(19) United States
(12) Patent Application Publication
(10) Pub. No.: US 2023/0410430 A1
(43) Pub. Date: Dec. 21, 2023

(54) SPATIAL MODELING BASED ON POINT COLLECTION AND VOXEL GRID

(71) Applicant: VEO ROBOTICS, INC., Waltham, MA (US)

(72) Inventors: Iris Kutsyy, Somerville, MA (US); Ilya A. Kriveshko, Boxborough, MA (US)

(21) Appl. No.: 18/359,981

(22) Filed: Jul. 27, 2023

Related U.S. Application Data
(63) Continuation-in-part of application No. 17/400,242, filed on Aug. 12, 2021.
Application No. 17/400,242 is a continuation-in-part of application No. 16/999,668, filed on Aug. 21, 2020, now abandoned.
Application No. 16/999,668 is a continuation-in-part of application No. 17/400,241, filed on Aug. 12, 2021.
Application No. 17/400,241 is a continuation-in-part of application No. 16/999,668, filed on Aug. 21, 2020, now abandoned.
(60) Provisional application No. 62/890,718, filed on Aug. 23, 2019.
(60) Provisional application No. 63/048,338, filed on Jul. 6, 2020.

(51) Int. Cl. G06T 17/20; B25J 9/16

(52) U.S. Cl. CPC G06T 17/205; B25J 9/163; B25J 9/1676; B25J 9/1666

(57) ABSTRACT

Systems and methods for spatially modeling a three-dimensional object are disclosed. In some embodiments, a disclosed method comprises: obtaining a polygon mesh including polygons representing a surface of an object; converting the polygon mesh into a triangle mesh including first triangles; subdividing the triangle mesh into a subdivided triangle mesh including second triangles, wherein the subdivided triangle mesh is overlaid with a voxel grid including a set of voxels; generating a point collection including a plurality of points each corresponding to a voxel in the voxel grid; and generating, based on the point collection and the voxel grid, at least one of: a surface point cloud representation, a surface voxel representation, or a volume voxel representation of the object.

### CROSS-REFERENCE TO RELATED APPLICATIONS

This application is a continuation-in-part of U.S. Ser. No. 17/400,242 filed on Aug. 12, 2021 and U.S. Ser. No. 17/400,241, filed on Aug. 12, 2021, each of which is a continuation-in-part of U.S. Ser. No. 16/999,668, filed on Aug. 21, 2020, which claims the benefit of and priority to U.S. Provisional Patent Application Nos. 62/890,718 (filed on Aug. 23, 2019) and 63/048,338 (filed on Jul. 6, 2020). The entire disclosures of the foregoing priority documents are hereby incorporated by reference.

### TECHNICAL FIELD

This application relates, generally, to spatially modeling and, in particular, spatially modeling a three-dimensional object based on a collection of points and a voxel grid.

### BACKGROUND

Traditional machinery for manufacturing and other industrial applications has been supplanted by, or supplemented with, new forms of automation that save costs, increase productivity and quality, eliminate dangerous, laborious, or repetitive work, and/or augment human capability. For example, industrial robots possess strength, speed, reliability, and lifetimes that may far exceed human potential. The recent trend toward increased human-robot collaboration in manufacturing workcells imposes particularly stringent requirements on robot performance and capabilities. Conventional industrial robots are dangerous to humans and are usually kept separate from humans through guarding—e.g., robots may be surrounded by a cage with doors that, when opened, cause an electrical circuit to place the machinery in a safe state. Other approaches involve light curtains or two-dimensional (2D) area sensors that slow down or shut off the machinery when humans approach it or cross a prescribed distance threshold. These systems disadvantageously constrain collaborative use of the workspace.

On the other hand, having humans and robots operate in the same workspace places additional demands on robot performance. Both may change position and configuration in rapid and unexpected ways, putting additional performance requirements on the robot's response times, kinematics, and dynamics. Typical industrial robots are fixed, but nonetheless have powerful arms that can cause injury over a wide “envelope” of possible movement trajectories; having knowledge of these trajectories in spaces where humans are present is thus fundamental to safe operation.

In general, robot arms comprise a number of mechanical links connected by revolute and prismatic joints that can be precisely controlled, and a controller coordinates all of the joints to achieve trajectories that are determined and programmed by an automation or manufacturing engineer for a specific application. Systems that can accurately control the robot trajectory are essential for safety in collaborative human-robot applications. However, the accuracy of industrial robots is limited by factors such as manufacturing tolerances (e.g., relating to fabrication of the mechanical arm), joint friction, drive nonlinearities, and tracking errors of the control system. In addition, backlash or compliances in the drives and joints of these robot manipulators can limit the positioning accuracy and the dynamic performance of the robot arm.

Kinematic definitions of industrial robots, which describe the total reachable volume (or “joint space”) of the manipulator, are derived from the individual robot link geometry and their assembly. A dynamic model of the robot is generated by taking the kinematic definition as an input, adding to it information about the speeds, accelerations, forces, range-of-motion limits, and moments that the robot is capable of at each joint interface, and applying a system identification procedure to estimate the robot dynamic model parameters. Accurate dynamic robot models are needed in many areas, such as mechanical design, workcell and performance simulation, control, diagnosis, safety and risk assessment, and supervision. For example, dexterous manipulation tasks and interaction with the environment, including humans in the vicinity of the robot, may demand accurate knowledge of the dynamic model of the robot for a specific application. Once estimated, robot model parameters can be used to compute stopping distances and other safety-related quantities. Because robot links are typically large, heavy metal castings fitted with motors, they have significant inertia while moving. Depending on the initial speed, payload, and robot orientation, a robot can take a significant time (and travel a great distance, many meters is not unusual) to stop after a stop command has been issued.

Dynamic models of robot arms are represented in terms of various inertial and friction parameters that are either measured directly or determined experimentally. While the model structure of robot manipulators is well known, the parameter values needed for system identification are not always available, since dynamic parameters are rarely provided by the robot manufacturers and often are not directly measurable. Determination of these parameters from computer-aided design (CAD) data or models may not yield a complete representation because they may not include dynamic effects like joint friction, joint and drive elasticities, and masses introduced by additional equipment such as end effectors, workpieces, or the robot dress package.

One important need for effective robotic system identification is in the estimation of joint acceleration characteristics and robot stopping distances for the safety rating of robotic equipment. As humans physically approach robotic arms, a safety system can engage and cut or reduce power to the arm, but robot inertia can keep the robot arm moving. The effective stopping distance (measured from the engagement of the safety system, such as a stopping command) is an important input for determining the safe separation distance from the robot arm given inertial effects. Similarly, all sensor systems include some amount of latency, and joint acceleration characteristics determine how the robot's state can change between measurement and application of control output. Robot manufacturers usually provide curves or graphs showing stopping distances and times, but these curves can be difficult to interpret, may be sparse and of low resolution, tend to reflect specific loads, and typically do not include acceleration or indicate the robot position at the time of engaging the stop. An improved approach to modeling and predicting robot dynamics under constraints and differing environmental conditions (such as varying payloads and end effectors) is set forth in U.S. Patent Publication No. 2020/0070347, now U.S. Pat. No. 11,254,004, the entire disclosure of which is hereby incorporated by reference.

Even with robot behavior fully modeled, however, safe operation for a given application—particularly if that application involves interaction with or proximity to humans depends on the spatial arrangement of the workspace, the relative positions of the robot and people or vulnerable objects, the task being performed, and robot stopping capabilities. For example, if robot movements are simple and consistently repeated over short periods, nearby human operators can observe and quickly learn them, and safely and easily plan and execute their own actions without violating safe separation distance. However, if robot movements are more complex or aperiodic, or if they happen over longer periods or broader areas, then nearby humans can err in predicting robot movement and move in a way that can violate safe separation distance.

Accordingly, there is a need for approaches that facilitate spatial modeling by incorporating human-robot collaboration and, if desired, visualization of calculated safe or unsafe regions in the vicinity of a robot and/or a human operator based on the task performed by the robot and/or the human operator. This approach should apply more generally to any type of industrial machinery that operates in proximity to and/or collaboration with human workers.

In general, three dimensional (3D) shapes can be modeled using CAD software, which often uses a 3D object representation that is specific to that software. In order to use the 3D object in other software, the CAD software supports exporting each 3D object as a polygonal mesh, which is a collection of polygons in three dimensions, representing a surface of the 3D object. Additionally, objects may be modeled directly as a polygonal mesh. Each polygon in a polygon mesh has vertices (meaning the points at the corners) and edges (meaning the lines connecting vertices). In general, polygon meshes may have disconnected components or breaks in the surface, where a polygon's edge is not connected to another polygon, which means a polygon mesh may be discontinuous and have holes. These may occur due to user or software error, or as an intentional part of the mesh definition.

A point cloud representation of an object is a list of points in 3D space. For example, a surface point cloud includes points on the surface of an object. A point cloud representation can be a highly efficient representation, and is useful in many software applications. The convex hull of a point cloud is the smallest convex (meaning containing only inward angles) polygon mesh that fully contains the point cloud.

A typical approach for computing point cloud representations is random sampling, where a number of points proportional to a surface area of an object are randomly selected on the surface. This approach has a number of drawbacks. If a section of the object has a larger surface area, it will need more points. If the object describes detailed geometry (e.g. the threads on screws, or internal gearboxes), this will result in a point cloud with more points despite not being a better representation, as the points will be highly clustered around areas such as screws and gearboxes due to the large surface areas there. Further, the number of points generated is highly dependent on the detail of the mesh. For example, compare an object that is modeled as a simple cube to one modeled as a cube with both interior and exterior walls. The latter will have double the surface area, despite representing the same object. The random sampling approach would thus produce a point cloud that is twice as large despite representing the same object. In addition, this method can lead to significant inaccuracies. Since the locations of points are chosen randomly, the maximum possible error is equal to the size of the object. With poor luck, the entire surface of the object may not be represented in the point cloud. In particular, long and thin objects will be poorly represented, as they have small surface area and it is unlikely that a point will be placed near the tip of them. Thus the tip will not be represented in the point cloud, which is an undesirable result.

A voxel representation (voxelization) of an object is a list of cubes arranged on a regular 3D grid. Listed cubes are considered “occupied” by the object. A voxel representation is often useful as it explicitly contains information about what volume the shape occupies.

A first common approach for computing voxel representations of an object is to overlay a voxel grid over the object, and for each voxel within the axis-aligned bounding box of the object, compute if it is within the object. This can be done in a number of ways, all of which must check the location of the voxel relative to every polygon in the mesh. This is a slow algorithm and takes a significant amount of computation time, which is proportional to the number of polygons in the mesh times the number of voxels in the bounding box. A variation of this approach is to first compute a point cloud, then take the convex hull of the point cloud. This convex hull is used as the polygon mesh in the first common approach. This variation is still slow and produces a voxelization that can be significantly larger than the object, since the convex hull can contain areas that are not in the original mesh.

### SUMMARY

The present teaching is directed to approaches for modeling the dynamics of machinery and/or human activities in a workspace for safety by taking into account collaborative workflows and processes. Although the ensuing discussion focuses on industrial robots, it should be understood that the present teaching and the approaches described herein are applicable to any type of controlled industrial machinery whose operation occurs in the vicinity of, and can pose a danger to, human workers.

In various embodiments, the spatial regions potentially occupied by any portion of the robot (or other machinery) and the human operator within a defined time interval or during performance of all or a defined portion of a task or an application are generated, e.g., calculated dynamically and, if desired, represented visually. These “potential occupancy envelopes” (POEs) may be based on the states (e.g., the current and expected positions, velocities, accelerations, geometry and/or kinematics) of the robot and the human operator (e.g., in accordance with the ISO 13855 standard, “Positioning of safeguards with respect to the approach speeds of parts of the human body”). POEs may be computed based on a simulation of the robot's performance of a task, with the simulated trajectories of moving robot parts (including workpieces) establishing the three-dimensional (3D) contours of the POE in space. Alternatively, POEs may be obtained based on observation (e.g., using 3D sensors) of the robot as it performs the task, with the observed trajectories used to establish the POE contours.

In some embodiments, a “keep-in” zone and/or a “keep-out” zone associated with the robot can be defined, e.g., based on the POEs of the robot and human operator. In the former case, operation of the robot is constrained so that all portions of the robot and workpieces remain within the spatial region defined by the keep-in zone. In the latter case, operation of the robot is constrained so that no portions of the robot and workpieces penetrate the keep-out zone. Based on the POEs of the robot and human operator and/or the keep-in/keep-out zones, movement of the robot during physical performance of the activity may be restricted in order to ensure safety.

In addition, the workspace parameters, such as the dimensions thereof, the workflow, the locations of the resources (e.g., the workpieces or supporting equipment), etc. can be modeled based on the computed POEs, thereby achieving high productivity and spatial efficiency while ensuring safety of the human operator. In one embodiment, the POEs of the robot and the human operator are both presented on a local display (a screen, a VR/AR headset, etc., e.g., as described in U.S. Ser. No. 16/919,959, filed on Jul. 2, 2020, now U.S. Pat. No. 11,518,051, the entire disclosure of which is hereby incorporated by reference) and/or communicated to a smartphone or tablet application for display thereon; this allows the human operator to visualize the space that is currently occupied or will be potentially occupied by the robot or the human operator, thereby enabling the operator to plan motions efficiently around the POE and further ensuring safety.

In various embodiments, one or more two-dimensional (2D) and/or three-dimensional (3D) imaging sensors are employed to scan the robot, human operator and/or workspace during actual execution of the task. Based thereon, the POEs of the robot and the human operator can be updated in real-time and provided as feedback to adjust the state (e.g., position, orientation, velocity, acceleration, etc.) of the robot and/or the modeled workspace. In some embodiments, the scanning data is stored in memory and can be used as an input when modeling the workspace in the same human-robot collaborative application next time. In some embodiments, robot state can be communicated from the robot controller, and subsequently validated by the 2D and/or 3D imaging sensors. In other embodiments, the scanning data may be exported from the system in a variety of formats for use in other CAD software. In still other embodiments, the POE is generated by simulating performance (rather than scanning actual performance) of a task by a robot or other machinery.

Additionally or alternatively, a protective separation distance (PSD) defining the minimum distance separating the robot from the operator and/or other safety-related entities can be computed. Again, the PSD may be continuously updated based on the scanning data of the robot and/or human operator acquired during execution of the task. In one embodiment, information about the computed PSD is combined with the POE of the human operator; based thereon, an optimal path of the robot in the workspace can then be determined.

Accordingly, in a first aspect, the present teaching pertains to a safety system for enforcing safe operation of machinery performing an activity in a three-dimensional (3D) workspace. In various embodiments, the system comprises a computer memory for storing (i) a model of the machinery and its permitted movements and (ii) a safety protocol specifying speed restrictions of the machinery in proximity to a human and a minimum separation distance between the machinery and a human, and a processor configured to computationally generate, from the stored images, a 3D spatial representation of the workspace; simulate, via a simulation module, performance of at least a portion of the activity by the machinery in accordance with the stored model; map, via a mapping module, a first 3D region of the workspace corresponding to space occupied by the machinery within the workspace augmented by a 3D envelope around the machinery spanning movements simulated by the simulation module; identify a second 3D region of the workspace corresponding to space occupied or potentially occupied by a human within the workspace augmented by a 3D envelope around the human corresponding to anticipated movements of the human within the workspace within a predetermined future time; and during physical performance of the activity, restrict operation of the machinery in accordance with a safety protocol based on proximity between the first and second regions.

In some embodiments, the simulation module is configured to dynamically simulate the first and second 3D regions of the workspace based at least in part on current states associated with the machinery and the human, where the current states comprise at least one of current positions, current orientations, expected positions associated with a next action in the activity, expected orientations associated with the next action in the activity, velocities, accelerations, geometries and/or kinematics. The first 3D region may be confined to a spatial region reachable by the machinery only during performance of the activity; it may include a global spatial region reachable by the machinery during performance of any activity. In various embodiments, the workspace is computationally represented as a plurality of voxels.

The safety system may, in some embodiments, also include a computer vision system that itself comprises a plurality of sensors distributed about the workspace, each of the sensors being associated with a grid of pixels for recording images of a portion of the workspace within a sensor field of view, the images including depth information; and an object-recognition module for recognizing the human and the machinery and movements thereof. The workspace portions may collectively cover the entire workspace.

In various embodiments, the first 3D region is divided into a plurality of nested, spatially distinct 3D subzones. Overlap between the second 3D region and each of the subzones may result in a different degree of alteration of the operation of the machinery. The processor may be further configured to recognize a workpiece being handled by the machinery and treat the workpiece as a portion thereof in identifying the first 3D region, and/or may be further configured to recognize a workpiece being handled by the human and treat the workpiece as a portion of the human in identifying the second 3D region.

Alternatively or in addition, the processor may be configured to dynamically control operation of the machinery so that it may be brought to a safe state without contacting a human in proximity thereto. The processor may be further configured to acquire scanning data of the machinery and the human during performance of the task, and update the first and second 3D regions based at least in part on the scanning data of the machinery and the human operator, respectively. The processor may be further configured to stop the machinery during physical performance of the activity if the machinery is determined to have deviated outside of operating outside the simulated 3D region; similarly, the processor may be further configured to preemptively stop the machinery during physical performance of the activity based on predicted operation of the machinery before a potential deviation event such that inertia does not cause the machine to deviate outside of the simulated 3D region.

In another aspect, the present teaching relates to a method enforcing safe operation of machinery performing an activity in a 3D workspace. In various embodiments, the method comprises electronically storing (i) a model of the machinery and its permitted movements and (ii) a safety protocol specifying speed restrictions of the machinery in proximity to a human and a minimum separation distance between the machinery and a human; computationally generating, from the stored images, a 3D spatial representation of the workspace; computationally simulating performance of at least a portion of the activity by the machinery in accordance with the stored model; computationally mapping a first 3D region of the workspace corresponding to space occupied by the machinery within the workspace augmented by a 3D envelope around the machinery spanning computationally simulated movements; computationally identify a second 3D region of the workspace corresponding to space occupied or potentially occupied by a human within the workspace augmented by a 3D envelope around the human corresponding to anticipated movements of the human within the workspace within a predetermined future time; and during physical performance of the activity, restricting operation of the machinery in accordance with a safety protocol based on proximity between the first and second regions.

The simulation step may comprise dynamically simulating the first and second 3D regions of the workspace based at least in part on current states associated with the machinery and the human, where the current states comprise one or more of current positions, current orientations, expected positions associated with a next action in the activity, expected orientations associated with the next action in the activity, velocities, accelerations, geometries and/or kinematics. The first 3D region may be confined to a spatial region reachable by the machinery only during performance of the activity; it may include a global spatial region reachable by the machinery during performance of any activity. In various embodiments, the workspace is computationally represented as a plurality of voxels.

The method may further include providing a plurality of sensors distributed about the workspace, where each of the sensors is associated with a grid of pixels for recording images of a portion of the workspace within a sensor field of view, the images including depth information; and computationally recognizing, based on the images, the human and the machinery and movements thereof. The workspace portions may collectively cover the entire workspace and the first 3D region may be divided into a plurality of nested, spatially distinct 3D subzones. Overlap between the second 3D region and each of the subzones may result in a different degree of alteration of the operation of the machinery.

In some embodiments, the method further comprises computationally recognizing a workpiece being handled by the machinery and treating the workpiece as a portion thereof in identifying the first 3D region and/or computationally recognizing a workpiece being handled by the human and treating the workpiece as a portion of the human in identifying the second 3D region. The method may include dynamically controlling operation of the machinery so that it may be brought to a safe state without contacting a human in proximity thereto.

In various embodiments, the method further comprises acquiring scanning data of the machinery and the human during performance of the task and updating the first and second 3D regions based at least in part on the scanning data of the machinery and the human operator, respectively. The method may further include stopping the machinery during physical performance of the activity if the machinery is determined to have deviated outside of operating outside the simulated 3D region and/or preemptively stopping the machinery during physical performance of the activity based on predicted operation of the machinery before a potential deviation event such that inertia does not cause the machine to deviate outside of the simulated 3D region.

Another aspect of the present teaching relates to a safety system for enforcing safe operation of machinery performing an activity in a 3D workspace. In various embodiments, the system comprises a computer memory for storing (i) a model of the machinery and its permitted movements and (ii) a safety protocol specifying speed restrictions of the machinery in proximity to a human and a minimum separation distance between the machinery and a human; and a processor configured to computationally generate, from the stored images, a 3D spatial representation of the workspace; map, via a mapping module, a first 3D region of the workspace corresponding to space occupied by the machinery within the workspace augmented by a 3D envelope around the machinery spanning all movements executed by the machinery during performance of the activity; map, via the mapping module, a second 3D region of the workspace corresponding to a portion of the first 3D region predictively occupied by the machinery during an interval beginning at a current time; identify a third 3D region of the workspace corresponding to space occupied or potentially occupied by a human within the workspace augmented by a 3D envelope around the human corresponding to anticipated movements of the human within the workspace during the interval; and during physical performance of the activity, restrict operation of the machinery in accordance with the safety protocol based on proximity between the second and third regions. The interval may correspond to a time required to bring the machinery to a safe state.

The interval may be based at least in part on a worst-case time required to bring the machinery to a safe state or at least in part on a worst-case stopping time of the machinery in a direction toward the third 3D region of the workspace. The interval may be based at least in part on a current state specifying a position, velocity and acceleration of the machinery, and/or may be based on programmed movements of the machinery in performing the activity beginning at the current time.

In various embodiments, the system further includes a plurality of sensors distributed about the workspace. Each of the sensors is associated with a grid of pixels for recording images of a portion of the workspace within a sensor field of view, and the workspace portions collectively cover the entire workspace. The mapping module is configured to compute the first 3D region of the workspace based on images generated by the sensors during performance of the activity by the machinery. The system may further include a simulation module, with the mapping module configured to compute the first 3D region of the workspace based on simulation, by the simulation module, of performance of the activity by the machinery.

The first 3D region may be confined to a spatial region reachable by the machinery only during performance of the activity. It may include a global spatial region reachable by the machinery during performance of any activity. The workspace may be computationally represented as a plurality of voxels. In some embodiments, the system further comprises an object-recognition module for recognizing the human and the machinery and movements thereof.

The first 3D region may be divided into a plurality of nested, spatially distinct 3D subzones. Overlap between the second 3D region and each of the subzones may result in a different degree of alteration of the operation of the machinery.

In some embodiments, the processor is further configured to recognize a workpiece being handled by the machinery and treat the workpiece as a portion thereof in identifying the first 3D region. The processor may be further configured to recognize a workpiece being handled by the human and treat the workpiece as a portion of the human in identifying the third 3D region. The processor may be configured to dynamically control the maximum velocity of the machinery so as to prevent contact between the machinery and a human except when the machinery is stopped. Alternatively or in addition, the processor may be configured to compute the anticipated movements of the human within the workspace during the interval based on a current direction, velocity and acceleration of the human. Anticipated movements of the human within the workspace during the interval may be further based on a kinematic model of human motion.

In some embodiments, the processor is further configured to stop the machinery during physical performance of the activity if the machinery is determined to be operating outside the first 3D region, or to preemptively stop the machinery during physical performance of the activity based on predicted operation of the machinery inside the third 3D region during the interval.

Still another aspect of the present teaching pertains to a method of enforcing safe operation of machinery performing an activity in a 3D workspace. In various embodiments, the method comprises the steps of electronically storing (i) a model of the machinery and its permitted movements and (ii) a safety protocol specifying speed restrictions of the machinery in proximity to a human and a minimum separation distance between the machinery and a human; computationally generating, from the stored images, a 3D spatial representation of the workspace; computationally mapping a first 3D region of the workspace corresponding to space occupied by the machinery within the workspace augmented by a 3D envelope around the machinery spanning all movements executed by the machinery during performance of the activity; computationally mapping a second 3D region of the workspace corresponding to a portion of the first 3D region predictively occupied by the machinery during an interval beginning at a current time; computationally identifying a third 3D region of the workspace corresponding to space occupied or potentially occupied by a human within the workspace augmented by a 3D envelope around the human corresponding to anticipated movements of the human within the workspace during the interval; and during physical performance of the activity, restricting operation of the machinery in accordance with the safety protocol based on proximity between the second and third regions.

The interval may be based at least in part on a worst-case time required to bring the machinery to a safe state or at least in part on a worst-case stopping time of the machinery in a direction toward the third 3D region of the workspace. The interval may be based at least in part on a current state specifying a position, velocity and acceleration of the machinery, and/or may be based on programmed movements of the machinery in performing the activity beginning at the current time.

The method may also include providing a plurality of sensors distributed about the workspace. Each of the sensors is associated with a grid of pixels for recording images of a portion of the workspace within a sensor field of view, and the workspace portions collectively cover the entire workspace. The first 3D region of the workspace is mapped based on images generated by the sensors during performance of the activity by the machinery. Alternatively, the first 3D region of the workspace may be mapped based on computational simulation of performance of the activity by the machinery.

The first 3D region may be confined to a spatial region reachable by the machinery only during performance of the activity. It may include a global spatial region reachable by the machinery during performance of any activity. The workspace may be computationally represented as a plurality of voxels. The method may include computationally recognizing the human and the machinery and movements thereof.

The first 3D region may be divided into a plurality of nested, spatially distinct 3D subzones. In some embodiments, overlap between the second 3D region and each of the subzones results in a different degree of alteration of the operation of the machinery.

The method may include recognizing a workpiece being handled by the machinery and treating the workpiece as a portion thereof in identifying the first 3D region and/or may include recognizing a workpiece being handled by the human and treating the workpiece as a portion of the human in identifying the third 3D region. The method may include dynamically controlling the maximum velocity of the machinery so as to prevent contact between the machinery and a human except when the machinery is stopped.

Anticipated movements of the human within the workspace during the interval may be computed based on a current direction, velocity and acceleration of the human. Computation of the anticipated movements of the human within the workspace during the interval may be further based on a kinematic model of human motion.

In some embodiments, the method includes stopping the machinery during physical performance of the activity if the machinery is determined to be operating outside the first 3D region. Alternatively, the machinery may be preemptively stopped based on predicted operation of the machinery inside the third 3D region during the interval.

Yet another aspect of the present teaching relates to a safety system for enforcing safe operation of machinery performing an activity in a 3D workspace. In various embodiments, the system comprises a computer memory for storing (i) a model of the machinery and its permitted movements and (ii) a safety protocol specifying speed restrictions of the machinery in proximity to a human and a minimum separation distance between the machinery and a human; and a processor configured to computationally generate, from the stored images, a 3D spatial representation of the workspace; map, via a mapping module, a first 3D region of the workspace corresponding to space occupied by the machinery within the workspace augmented by a 3D envelope around the machinery spanning all movements executed by the machinery during performance of the activity; and identify a second 3D region of the workspace corresponding to space occupied or potentially occupied by a human within the workspace augmented by a 3D envelope around the human corresponding to anticipated movements of the human within the workspace during the interval. The computer memory also stores a geometric representation of a restriction zone within the first 3D region of the workspace and the processor is configured to, during physical performance of the activity, restrict operation of the machinery (a) in accordance with a safety protocol based on proximity between the first and second regions and (b) to remain within or outside the restriction zone.

The processor may be further configured to identify a pose and trajectory of the machinery based at least in part on state data provided by the machinery. The state data may be safety-rated and provided over a safety-rated communication protocol. Alternatively, the state data may not be safety-rated but is validated by information received from a plurality of sensors.

In various embodiments, the system further comprises a control system, executable by the processor and having safety-rated and non-safety-rated components; restriction of the operation of the machinery to remain within or outside the restriction zone is performed by the safety-rated component. The restriction zone may be a keep-out zone, in which case the mapping module may be further configured to determine a path along which the machinery can perform the activity without entering the keep-out zone. The restriction zone may be a keep-in zone, in which case the mapping module may be further configured to determine a path along which the machinery can perform the activity without leaving the keep-in zone.

In various embodiments, the safety protocol specifies a protective separation distance as a minimum distance separating the machinery from the human. The processor may be configured to, during physical performance of the activity, continuously compare an instantaneous measured distance between the machinery and the human to the protective separation distance and adjust an operating speed of the machinery based at least in part on the comparison. The processor may be configured to, during physical performance of the activity, govern an operating speed of the machinery to a set point at a distance larger than the protective separation distance. In some embodiments, the system also includes a control system, executable by the processor, having safety-rated and non-safety-rated components; the operating speed of the machinery is governed by the non-safety-rated component.

In some cases, the first 3D region is divided into a plurality of nested, spatially distinct 3D subzones. Overlap between the second 3D region and each of the subzones may thereby result in a different degree of alteration of the operation of the machinery. The processor may be further configured to recognize a workpiece being handled by the machinery and treat the workpiece as a portion thereof in identifying the first 3D region.

In still another aspect, the present teaching relates to a method of enforcing safe operation of machinery performing an activity in a 3D workspace. In various embodiments, the method comprises the steps of electronically storing (i) a model of the machinery and its permitted movements and (ii) a safety protocol specifying speed restrictions of the machinery in proximity to a human and a minimum separation distance between the machinery and a human; computationally generating, from the stored images, a 3D spatial representation of the workspace; computationally mapping a first 3D region of the workspace corresponding to space occupied by the machinery within the workspace augmented by a 3D envelope around the machinery spanning all movements executed by the machinery during performance of the activity; computationally identifying a second 3D region of the workspace corresponding to space occupied or potentially occupied by a human within the workspace augmented by a 3D envelope around the human corresponding to anticipated movements of the human within the workspace during the interval; electronically storing a geometric representation of a restriction zone within the first 3D region of the workspace; and during physical performance of the activity, restricting operation of the machinery in accordance with a safety protocol based on proximity between the first and second regions whereby the machinery remains within or outside the restriction zone.

In various embodiments, the method further comprises the step of identifying a pose and trajectory of the machinery based at least in part on state data provided by the machinery. The state data may be safety-rated and provided over a safety-rated communication protocol. Alternatively, the state data may not be safety-rated but is validated by information received from a plurality of sensors. The method may include providing a control system having safety-rated and non-safety-rated components, restriction of the operation of the machinery to remain within or outside the restriction zone being performed by the safety-rated component.

In some embodiments, the restriction zone is a keep-out zone and the method further includes computationally determining a path along which the machinery can perform the activity without entering the keep-out zone. In other embodiments, the restriction zone is a keep-in zone and the method further includes computationally determining a path along which the machinery can perform the activity without leaving the keep-in zone. The safety protocol may specify a protective separation distance as a minimum distance separating the machinery from the human. During physical performance of the activity, the method may include continuously comparing an instantaneous measured distance between the machinery and the human to the protective separation distance and adjusting the operating speed of the machinery based at least in part on the comparison. Alternatively or in addition, the method may include, during physical performance of the activity, governing the operating speed of the machinery to a set point at a distance larger than the protective separation distance.

In some embodiments, the method further comprises providing a control system having safety-rated and non-safety-rated components. The operating speed of the machinery may be governed by the non-safety-rated component.

In various embodiments, the first 3D region is divided into a plurality of nested, spatially distinct 3D subzones. Overlap between the second 3D region and each of the subzones may result in a different degree of alteration of the operation of the machinery. The method may include computationally recognizing a workpiece being handled by the machinery and treating the workpiece as a portion thereof in identifying the first 3D region.

Another aspect of the present teaching pertains to a system for spatially modeling a workspace in a human-robot collaborative application. In various embodiments, the system comprises a robot controller having a safety-rated component and a non-safety-rated component; an object-monitoring system configured to computationally generate a first potential occupancy envelope for a robot and a second potential occupancy envelope for a human operator when performing a task in the workspace, the first and second potential occupancy envelopes spatially encompassing movements performable by the robot and the human operator, respectively, during performance of the task; a first set of stored instructions executable by the non-safety-rated component of the controller for causing execution by the robot of a programmed task; and a second set of stored instructions executable by the safety-rated component of the controller for stopping or slowing the robot. The object-monitoring system may be configured to computationally detect a predetermined degree of proximity between the first and second potential occupancy envelopes and to thereupon cause the controller to put the robot in a safe state.

In some embodiments, the predetermined degree of proximity corresponds to a protective separation distance. It may be computed dynamically by the object-monitoring system based on the current state of the robot and the human operator.

In various embodiments, the system further comprises a computer vision system for monitoring the robot and the human operator. The object-monitoring system may be configured to reduce or enlarge the size of the first potential occupancy envelope in response to movement of the operator detected by the computer vision system. The object-monitoring system may be configured to issue commands (i) to the non-safety-rated component of the controller to slow the robot to operate at a reduced speed in accordance with a reduced-size potential occupancy envelope and (ii) to the safety-rated component of the controller to enforce robot operation at or below the reduced speed. Similarly, the object-monitoring system may be configured to issue commands (i) to the non-safety-rated component of the controller to increase a speed of the robot in accordance with an enlarged potential occupancy envelope and (ii) to the safety-rated component of the controller to enforce robot operation at or below the increased speed. In various embodiments, the safety-rated component of the controller is configured to enforce the reduced or enlarged first potential occupancy envelope as a keep-in zone.

In yet another aspect, the present teaching relates to a method of spatially modeling a workspace in a human-robot collaborative application. In various embodiments, the method comprises the steps of providing a robot controller having a safety-rated component and a non-safety-rated component; computationally generating a first potential occupancy envelope for a robot and a second potential occupancy envelope for a human operator when performing a task in the workspace, where the first and second potential occupancy envelopes spatially encompass movements performable by the robot and the human operator, respectively, during performance of the task; causing, by the non-safety-rated component of the controller, execution by the robot of a programmed task; and causing, by the safety-rated component of the controller, the robot to enter a safe state upon computational detection of a predetermined degree of proximity between the first and second potential occupancy envelopes.

In some embodiments, the predetermined degree of proximity corresponds to a protective separation distance. The predetermined degree of proximity may be computed dynamically based on a current state of the robot and the human operator.

In various embodiments, the method further comprises (i) computationally monitoring the robot and the human operator and (ii) reducing or enlarging the size of the first potential occupancy envelope in response to detected movement of the operator. The method may further comprise causing, by the non-safety-rated component of the controller, the robot to operate at a reduced speed in accordance with a reduced-size potential occupancy envelope and enforcing, by the safety-rated component of the controller, robot operation at or below the reduced speed. Similarly, the method may further comprise (i) causing, by the non-safety-rated component of the controller, a speed of the robot to increase in accordance with an enlarged potential occupancy envelope and (ii) enforcing, by the safety-rated component of the controller, robot operation at or below the increased speed. Alternatively or in addition, the method may further comprise enforcing, by the safety-rated component of the controller, the reduced or enlarged first potential occupancy envelope as a keep-in zone.

Some embodiments described herein are directed to systems and methods for spatially modeling a three-dimensional object. For example, the three-dimensional object may be a robot or a human operator in a workspace.

In one embodiment, a method for spatially modeling a three-dimensional object is disclosed. The method comprises: obtaining an object representative polygon mesh including a set of polygons in three dimensions, wherein the object representative polygon mesh represents a surface of the three-dimensional object; converting the object representative polygon mesh into an object representative triangle mesh including a set of first triangles; subdividing the object representative triangle mesh into a subdivided object representative triangle mesh including a set of second triangles, wherein the subdivided object representative triangle mesh is overlaid with a voxel grid including a set of voxels; generating a point collection including a plurality of points each corresponding to a voxel in the voxel grid, wherein each point is generated based on vertices of the subdivided object representative triangle mesh located in the voxels of the voxel grid; and generating, based on the point collection and the voxel grid, at least one of: a surface point cloud representation of the three-dimensional object, a surface voxel representation of the three-dimensional object, or a volume voxel representation of the three-dimensional object.

In another embodiment, a system for spatially modeling a three-dimensional object is disclosed. The system comprises: a non-transitory memory having instructions stored thereon; and at least one processor operatively coupled to the non-transitory memory. The at least one processor is configured to read the instructions to: obtain an object representative polygon mesh including a set of polygons in three dimensions, wherein the object representative polygon mesh represents a surface of the three-dimensional object; convert the object representative polygon mesh into an object representative triangle mesh including a set of first triangles; subdivide the object representative triangle mesh into a subdivided object representative triangle mesh including a set of second triangles, wherein the subdivided object representative triangle mesh is overlaid with a voxel grid including a set of voxels; generate a point collection including a plurality of points each corresponding to a voxel in the voxel grid, wherein each point is generated based on vertices of the subdivided object representative triangle mesh located in the voxels of the voxel grid; and generate, based on the point collection and the voxel grid, at least one of: a surface point cloud representation of the three-dimensional object, a surface voxel representation of the three-dimensional object, or a volume voxel representation of the three-dimensional object.

In a different embodiment, a non-transitory computer readable medium having instructions stored thereon for spatially modeling a three-dimensional object is disclosed. The instructions, when executed by at least one processor, cause at least one device to perform operations comprising: obtaining an object representative polygon mesh including a set of polygons in three dimensions, wherein the object representative polygon mesh represents a surface of the three-dimensional object; converting the object representative polygon mesh into an object representative triangle mesh including a set of first triangles; subdividing the object representative triangle mesh into a subdivided object representative triangle mesh including a set of second triangles, wherein the subdivided object representative triangle mesh is overlaid with a voxel grid including a set of voxels; generating a point collection including a plurality of points each corresponding to a voxel in the voxel grid, wherein each point is generated based on vertices of the subdivided object representative triangle mesh located in the voxels of the voxel grid; and generating, based on the point collection and the voxel grid, at least one of: a surface point cloud representation of the three-dimensional object, a surface voxel representation of the three-dimensional object, or a volume voxel representation of the three-dimensional object.

In various embodiments, the three-dimensional object being spatially modeled may be a human operator, a robot, or an object manipulated by a robot in a workspace.

In general, as used herein, the term “robot” means any type of controllable industrial equipment for performing automated operations—such as moving, manipulating, picking and placing, processing, joining, cutting, welding, etc.—on workpieces. The term “substantially” means±10%, and in some embodiments, ±5%. In addition, reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the present teaching. In the following description, various embodiments of the present teaching are described with reference to the following drawings, in which:

FIG. 1 is a perspective view of a human-robot collaborative workspace, in accordance with various embodiments of the present teaching;

FIG. 2 schematically illustrates a control system, in accordance with various embodiments of the present teaching;

FIGS. 3A-3C depict exemplary POEs of machinery (in particular, a robot arm), in accordance with various embodiments of the present teaching;

FIG. 4 depicts an exemplary task-level or application-level POE of machinery, in accordance with various embodiments of the present teaching, when the trajectory of the machinery does not change once programmed;

FIGS. 5A and 5B depict exemplary task-level or application-level POEs of the machinery, in accordance with various embodiments of the present teaching, when the trajectory of the machinery changes during operation;

FIGS. 6A and 6B depict exemplary POEs of a human operator, in accordance with various embodiments of the present teaching;

FIG. 7A depicts an exemplary task-level or application-level POE of a human operator when performing a task or an application, in accordance with various embodiments of the present teaching;

FIG. 7B depicts an exemplary truncated POE of a human operator, in accordance with various embodiments of the present teaching;

FIGS. 8A and 8B illustrate display of the POEs of the machinery and human operator, in accordance with various embodiments of the present teaching;

FIGS. 9A and 9B depict exemplary keep-in zones associated with the machinery, in accordance with various embodiments of the present teaching;

FIG. 10 schematically illustrates an object-monitoring system, in accordance with various embodiments of the present teaching;

FIGS. 11A and 11B depict dynamically updated POEs of the machinery, in accordance with various embodiments of the present teaching;

FIG. 12A depicts an optimal path for the machinery when performing a task or an application, in accordance with various embodiments of the present teaching;

FIG. 12B depicts limiting the velocity of the machinery in a safety-rated way, in accordance with various embodiments of the present teaching;

FIG. 13 schematically illustrates the definition of progressive safety envelopes in proximity to the machinery, in accordance with various embodiments of the present teaching;

FIGS. 14A and 14B are flow charts illustrating exemplary approaches for computing the POEs of the machinery and human operator, in accordance with various embodiments of the present teaching;

FIG. 15 is a flow chart illustrating an exemplary approach for determining a keep-in zone and/or a keep-out zone, in accordance with various embodiments of the present teaching;

FIG. 16 is a flow chart illustrating an approach for performing various functions in different applications based on the POEs of the machinery and human operator and/or the keep-in/keep-out zones, in accordance with various embodiments of the present teaching;

FIG. 17 illustrates an approach for spatially modeling a three-dimensional object, in accordance with various embodiments of the present teaching;

FIG. 18 illustrates an exemplary method for subdividing a triangle for spatially modeling a three-dimensional object, in accordance with various embodiments of the present teaching;

FIGS. 19A and 19B illustrate exemplary holes in a polygon mesh, in accordance with various embodiments of the present teaching;

FIG. 20 illustrates a robot to be spatially modeled, in accordance with various embodiments of the present teaching;

FIG. 21 illustrates a mesh representation of an end effector of a robot, in accordance with various embodiments of the present teaching;

FIG. 22 illustrates a subdivided mesh representation of an end effector of a robot, in accordance with various embodiments of the present teaching;

FIG. 23 illustrates endpoints of a subdivided mesh representation, in accordance with various embodiments of the present teaching;

FIG. 24 illustrates endpoints of a subdivided mesh representation with an overlaid grid, in accordance with various embodiments of the present teaching;

FIG. 25 illustrates target points in a grid, in accordance with various embodiments of the present teaching;

FIG. 26 illustrates chosen points and target points in a grid, in accordance with various embodiments of the present teaching;

FIG. 27 illustrates chosen points in a grid, in accordance with various embodiments of the present teaching;

FIG. 28 illustrates a point cloud representation of an end effector of a robot, in accordance with various embodiments of the present teaching;

FIG. 29 illustrates a surface voxelization of an end effector of a robot, in accordance with various embodiments of the present teaching;

FIG. 30 illustrates a volume voxelization of an end effector of a robot, in accordance with various embodiments of the present teaching;

FIG. 31 illustrates a point cloud representation of a robot, in accordance with various embodiments of the present teaching;

FIG. 32 illustrates a surface voxelization of a robot, in accordance with various embodiments of the present teaching;

FIG. 33 illustrates a volume voxelization of a robot, in accordance with various embodiments of the present teaching; and

FIG. 34 is a flow chart illustrating a method for spatially modeling a three-dimensional object, in accordance with various embodiments of the present teaching.

### DETAILED DESCRIPTION

The following discussion describes an integrated system and methods for fully modeling and/or computing in real time the robot dynamics and/or human activities in a workspace for safety. In some cases, this involves semantic analysis of a robot in the workspace and identification of the workpieces with which it interacts. It should be understood, however, that these various elements may be implemented separately or together in desired combinations; the inventive aspects discussed herein do not require all of the described elements, which are set forth together merely for ease of presentation and to illustrate their interoperability. The system as described represents merely one embodiment.

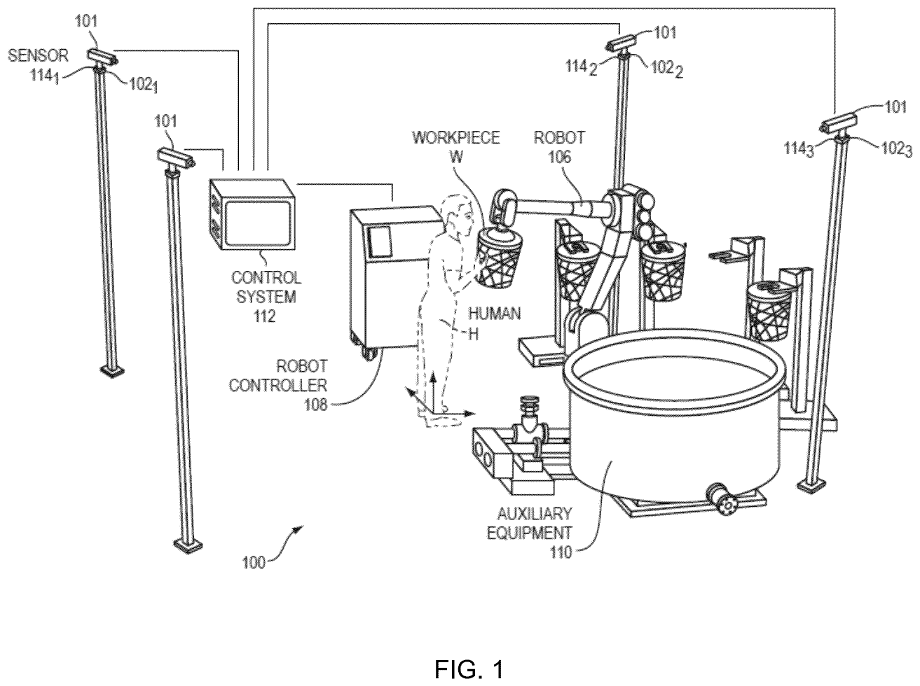

Refer first to FIG. 1, which illustrates a representative human-robot collaborative workspace 100 equipped with a safety system including a sensor system 101 having one or more sensors representatively indicated at 102₁, 102₂, 102₃ for monitoring the workspace 100. Each sensor may be associated with a grid of pixels for recording data (such as images having depth, range or any 3D information) of a portion of the workspace within the sensor field of view. The sensors 102₁₋₃ may be conventional optical sensors such as cameras, e.g., 3D time-of-flight (ToF) cameras, stereo vision cameras, or 3D LIDAR sensors or radar-based sensors, ideally with high frame rates (e.g., between 25 frames per second (FPS) and 100 FPS). The mode of operation of the sensors 102₁₋₃ is not critical so long as a 3D representation of the workspace 100 is obtainable from images or other data obtained by the sensors 102₁₋₃. The sensors 102₁₋₃ may collectively cover and can monitor the entire workspace (or at least a portion thereof) 100, which includes a robot 106 controlled by a conventional robot controller 108. The robot 106 interacts with various workpieces W, and a human operator H in the workspace 100 may interact with the workpieces W and/or the robot 106 to perform a task. The workspace 100 may also contain various items of auxiliary equipment 110. As used herein the robot 106 and auxiliary equipment 110 are denoted as machinery in the workspace 100.

In various embodiments, data obtained by each of the sensors 102₁₋₃ is transmitted to a control system 112. Based thereon, the control system 112 may computationally generate a 3D spatial representation (e.g., voxels) of the workspace 100, recognize the robot 106, human operator and/or workpiece handled by the robot and/or human operator, and track movements thereof as further described below. In addition, the sensors 102₁₋₃ may be supported by various software and/or hardware components 114₁₋₃ for changing the configurations (e.g., orientations and/or positions) of the sensors 102₁₋₃; the control system 112 may be configured to adjust the sensors so as to provide optimal coverage of the monitored area in the workspace 100. The volume of space covered by each sensor—typically a solid truncated pyramid or solid frustum may be represented in any suitable fashion, e.g., the space may be divided into a 3D grid of small (5 cm, for example) voxels or other suitable form of volumetric representation. For example, a 3D representation of the workspace 100 may be generated using 2D or 3D ray tracing. This ray tracing can be performed dynamically or via the use of precomputed volumes, where objects in the workspace 100 are previously identified and captured by the control system 112. For convenience of presentation, the ensuing discussion assumes a voxel representation, and the control system 112 maintains an internal representation of the workspace 100 at the voxel level.

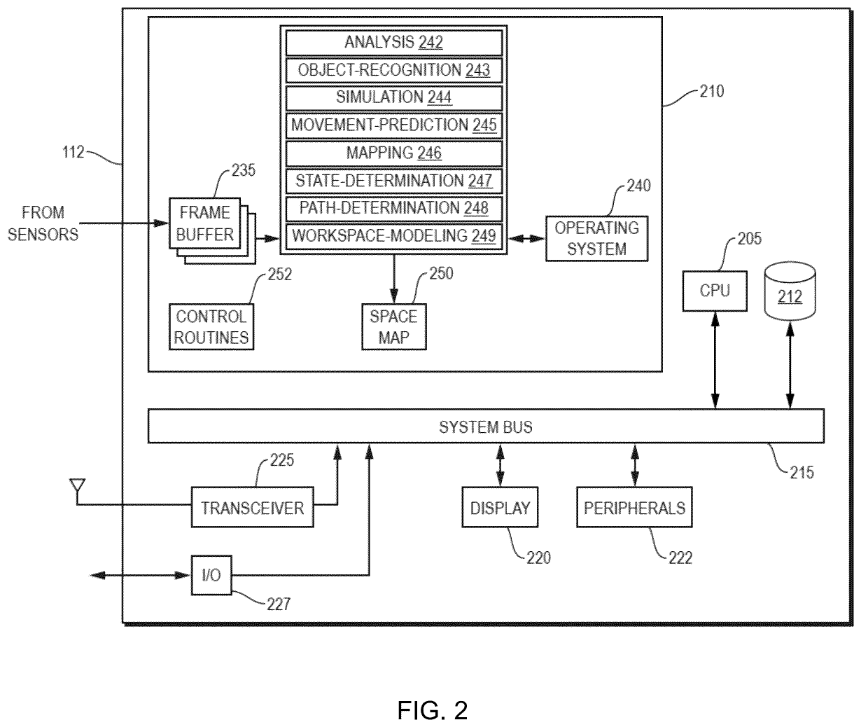

FIG. 2 illustrates, in greater detail, a representative embodiment of the control system 112, which may be implemented on a general-purpose computer. The control system 112 includes a central processing unit (CPU) 205, system memory 210, and one or more non-volatile mass storage devices (such as one or more hard disks and/or optical storage units) 212. The control system 112 further includes a bidirectional system bus 215 over which the CPU 205, functional modules in the memory 210, and storage device 212 communicate with each other as well as with internal or external input/output (I/O) devices, such as a display 220 and peripherals 222 (which may include traditional input devices such as a keyboard or a mouse). The control system 112 also includes a wireless transceiver 225 and one or more I/O ports 227. The transceiver 225 and I/O ports 227 may provide a network interface. The term “network” is herein used broadly to connote wired or wireless networks of computers or telecommunications devices (such as wired or wireless telephones, tablets, etc.). For example, a computer network may be a local area network (LAN) or a wide area network (WAN). When used in a LAN networking environment, computers may be connected to the LAN through a network interface or adapter; for example, a supervisor may establish communication with the control system 112 using a tablet that wirelessly joins the network. When used in a WAN networking environment, computers typically include a modem or other communication mechanism. Modems may be internal or external, and may be connected to the system bus via the user-input interface, or other appropriate mechanism. Networked computers may be connected over the Internet, an Intranet, Extranet, Ethernet, or any other system that provides communications. Some suitable communications protocols include TCP/IP, UDP, or OSI, for example. For wireless communications, communications protocols may include IEEE 802.11x (“Wi-Fi”), Bluetooth, ZigBee, IrDa, near-field communication (NFC), or other suitable protocol. Furthermore, components of the system may communicate through a combination of wired or wireless paths, and communication may involve both computer and telecommunications networks.

The CPU 205 is typically a microprocessor, but in various embodiments may be a microcontroller, peripheral integrated circuit element, a CSIC (customer-specific integrated circuit), an ASIC (application-specific integrated circuit), a logic circuit, a digital signal processor, a programmable logic device such as an FPGA (field-programmable gate array), PLD (programmable logic device), PLA (programmable logic array), RFID processor, graphics processing unit (GPU), smart chip, or any other device or arrangement of devices that is capable of implementing the steps of the processes of the present teaching.

The system memory 210 may store a model of the machinery characterizing its geometry and kinematics and its permitted movements in the workspace. The model may be obtained from the machinery manufacturer or, alternatively, generated by the control system 112 based on the scanning data acquired by the sensor system 101. In addition, the memory 210 may store a safety protocol specifying various safety measures such as speed restrictions of the machinery in proximity to the human operator, a minimum separation distance between the machinery and the human, etc. In some embodiments, the memory 210 contains a series of frame buffers 235, i.e., partitions that store, in digital form (e.g., as pixels or voxels, or as depth maps), images obtained by the sensors 102₁₋₃; the data may actually arrive via I/O ports 227 and/or transceiver 225 as discussed above.

The system memory 210 contains instructions, conceptually illustrated as a group of modules, that control the operation of CPU 205 and its interaction with the other hardware components. An operating system 240 (e.g., Windows or Linux) directs the execution of low-level, basic system functions such as memory allocation, file management and operation of the mass storage device 212. At a higher level, and as described in greater detail below, an analysis module 242 may register the images acquired by the sensor system 101 in the frame buffers 235, generate a 3D spatial representation (e.g., voxels) of the workspace and analyze the images to classify regions of the monitored workspace 100; an object-recognition module 243 may recognize the human and the machinery and movements thereof in the workspace based on the data acquired by the sensor system 101; a simulation module 244 may computationally perform at least a portion of the application/task performed by the machinery in accordance with the stored machinery model and application/task; a movement prediction module 245 may predict movements of the machinery and/or the human operator within a defined future interval (e.g., 0.1 sec, 0.5 sec, 1 sec, etc.) based on, for example, the current state (e.g., position, orientation, velocity, acceleration, etc.) thereof; a mapping module 246 may map or identify the POEs of the machinery and/or the human operator within the workspace; a state determination module 247 may determine an updated state of the machinery such that the machinery can be operated in a safe state; a path determination module 248 may determine a path along which the machinery can perform the activity; and a workspace modeling module 249 may model the workspace parameter (e.g., the dimensions, workflow, locations of the equipment and/or resources). The result of the classification, object recognition and simulation as well as the POEs of the machinery and/or human, the determined optimal path and workspace parameters may be stored in a space map 250, which contains a volumetric representation of the workspace 100 with each voxel (or other unit of representation) labeled, within the space map, as described herein. Alternatively, the space map 250 may simply be a 3D array of voxels, with voxel labels being stored in a separate database (in memory 210 or in mass storage 212).

In addition, the control system 112 may communicate with the robot controller 108 to control operation of the machinery in the workspace 100 (e.g., performing a task/application programmed in the controller 108 or the control system 112) using conventional control routines collectively indicated at 252. As explained below, the configuration of the workspace may well change over time as persons and/or machines move about; the control routines 252 may be responsive to these changes in operating machinery to achieve high levels of safety. All of the modules in system memory 210 may be coded in any suitable programming language, including, without limitation, high-level languages such as C, C++, C#, Java, Python, Ruby, Scala, and Lua, utilizing, without limitation, any suitable frameworks and libraries such as TensorFlow, Keras, PyTorch, Caffe or Theano. Additionally, the software can be implemented in an assembly language and/or machine language directed to the microprocessor resident on a target device.

When a task/application involves human-robot collaboration, it may be desired to model and/or compute, in real time, the robot dynamics and/or human activities and provide safety mapping of the robot and/or human in the workspace 100. Mapping a safe and/or unsafe region in human-robot collaborative applications, however, is a complicated process because, for example, the robot state (e.g., current position, velocity, acceleration, payload, etc.) that represents the basis for extrapolating to all possibilities of the robot speed, load, and extension is subject to abrupt change. These possibilities typically depend on the robot kinematics and dynamics (including singularities and handling of redundant axes, e.g., elbow-up or elbow-down configurations) as well as the dynamics of the end effector and workpiece. Moreover, the safe region may be defined in terms of a degree rather than simply as “safe.” The process of modeling the robot dynamics and mapping the safe region, however, may be simplified by assuming that the robot's current position is fixed and estimating the region that any portion of the robot may conceivably occupy within a short future time interval only. Thus, various embodiments of the present teaching include approaches to modeling the robot dynamics and/or human activities in the workspace 100 and mapping the human-robot collaborative workspace 100 (e.g., calculating the safe and/or unsafe regions) over short intervals based on the current states (e.g., current positions, velocities, accelerations, geometries, kinematics, expected positions and/or orientations associated with the next action in the task/application) associated with the machinery (including the robot 106 and/or other industrial equipment) and the human operator. In addition, the modeling and mapping procedure may be repeated (based on, for example, the scanning data of the machinery and the human acquired by the sensor system 101 during performance of the task/application) over time, thereby effectively updating the safe and/or unsafe regions on a quasi-continuous basis in real time.

To model the robot dynamics and/or human activities in the workspace 100 and map the safe and/or unsafe regions, in various embodiments, the control system 112 first computationally generates a 3D spatial representation (e.g., as voxels) of the workspace 100 where the machinery (including the robot 106 and auxiliary equipment), workpiece and human operator are based on, for example, the scanning data acquired by the sensor system 101. In addition, the control system 112 may access the memory 210 or mass storage 212 to retrieve a model of the machinery characterizing the geometry and kinematics of the machinery and its permitted movements in the workspace. The model may be obtained from the robot manufacturer or, alternatively, generated by the control system 112 based on the scanning data acquired by the sensor system prior to mapping the safe and/or unsafe regions in the workspace 100. Based on the machinery model and the currently known information about the machinery, a spatial POE of the machinery can be estimated. As a spatial map, the POE may be represented in any computationally convenient form, e.g., as a cloud of points, a grid of voxels, a vectorized representation, or other format. For convenience, the ensuing discussion will assume a voxel representation.

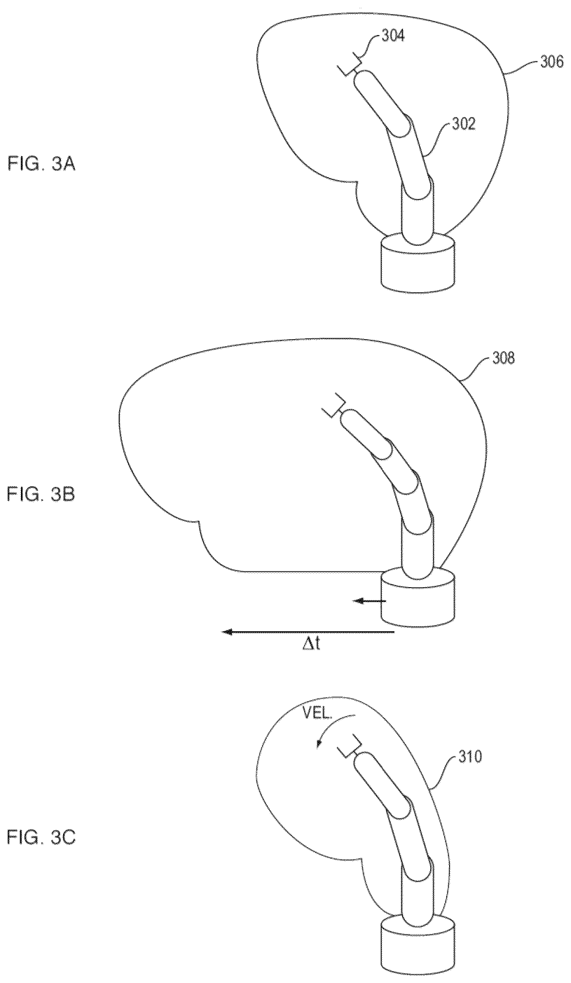

FIG. 3A illustrates a scenario in which only the current position of a robot 302 and the current state of an end-effector 304 are known. To estimate the spatial POE 306 of the robot 302 and the end-effector 304 within a predetermined time interval, it may be necessary to consider a range of possible starting velocities for all joints of the robot 302 (since the robot joint velocities are unknown) and allow the joint velocities to evolve within the predetermined time interval according to accelerations/decelerations consistent with the robot kinematics and dynamics. The entire spatial region 306 that the robot and end-effector may potentially occupy within the predetermined time interval is herein referred to as a static, “robot-level” POE. Thus, the robot-level POE may encompass all points that a stationary robot may possibly reach based on its geometry and kinematics, or if the robot is mobile, may extend in space to encompass the entire region reachable by the robot within the predefined time. For example, referring to FIG. 3B, if the robot is constrained to move along a linear track, the robot-level POE 308 would correspond to a linearly stretched version of the stationary robot POE 306, with the width of the stretch dictated by the chosen time window Δt.

In one embodiment, the POE 306 represents a 3D region which the robot and end-effector may occupy before being brought to a safe state. Thus, in this embodiment, the time interval for computing the POE 306 is based on the time required to bring the robot to the safe state. For example, referring again to FIG. 3A, the POE 306 may be based on the worst-case stopping times and distances (e.g., the longest stopping times with the furthest distances) in all possible directions. Alternatively, the POE 306 may be based on the worst-case stopping time of the robot in a direction toward the human operator. In some embodiments, the POE 306 is established at an application or task level, spanning all voxels potentially reached by the robot during performance of a particular task/application as further described below.

In addition, the POE 306 may be refined based on safety features of the robot 106; for example, the safety features may include a safety system that initiates a protective stop even when the velocity or acceleration of the robot is not known. Knowing that a protective stop has been initiated and its protective stop input is being held may effectively truncate the POE 306 of the robot (since the robot will only decelerate until a complete stop is reached). In one embodiment, the POE 306 is continuously updated at fixed time intervals (thereby changing the spatial extent thereof in a stepwise manner) during deceleration of the robot; thus, if the time intervals are sufficiently short, the POE 306 is effectively updated on a quasi-continuous basis in real time.

FIG. 3C depicts another scenario where the robot's state—e.g., the position, velocity and acceleration—are known. In this case, based on the known movement in a particular direction with a particular speed, a more refined (and smaller) time-bounded POE 310 may be computed based on the assumption that the protective stop may be initiated. In one embodiment, the reduced-size POE 310 corresponding to a short time interval is determined based on the instantaneously calculated deceleration from the current, known velocity to a complete stop and then acceleration to a velocity in the opposite direction within the short time interval.

In various embodiments, the POE of the machinery is more narrowly defined to correspond to the execution of a task or an application, i.e., all points that the robot may or can reach during performance of the task/application. This “task-level” or “application-level” POE may be estimated based on known robot operating parameters and the task/application program executed by the robot controller. For example, the control system 112 may access the memory 210 and/or storage 212 to retrieve the model of the machinery and the task/application program that the machinery will execute. Based thereon, the control system 112 may simulate operation of the machinery in a virtual volume (e.g., defined as a spatial region of voxels) in the workspace 100 for performing the task/application. The simulated machinery may sweep out a path in the virtual volume as the simulation progresses; the voxels that represent the spatial volume encountered by the machinery for performing the entire task/application correspond to a static task-level or application-level POE. In addition, because the machinery dynamically changes its trajectory (e.g., the pose, velocity and acceleration) during execution of the task/application, a dynamic POE may be defined as the spatial region that the machinery, as it performs the task/application, may reach from its current position within a predefined time interval. The dynamic POE may be determined based on the current state (e.g., the current position, current velocity and current acceleration) of the machinery and the programmed movements of the machinery in performing the task/application beginning at the current time. Thus, the dynamic POE may vary throughout performance of the entire task/application—i.e., different sub-tasks (or sub-applications) may correspond to different POEs. In one embodiment, the POE associated with each sub-task or sub-application has a timestamp representing its temporal relation with the initial POE associated with the initial position of the machinery when it commences the task/application. The overall task-level or application-level POE (i.e., the static task-level or application-level POE) then corresponds to the union of all possible sub-task-level or sub-application-level POEs (i.e., the dynamic task-level or application-level POEs).

In some embodiments, parameters of the machinery are not known with sufficient precision to support an accurate simulation; in this case, the actual machinery may be run through the entire task/application routine and all joint positions at every point in time during the trajectory are recorded (e.g., by the sensory system 101 and/or the robot controller). Additional characteristics that may be captured during the recording include (i) the position of the tool-center-point in X, Y, Z, R, P, Y coordinates; (ii) the positions of all robot joints in joint space, J1, J2, J3, J4, J5, J6, . . . Jn; and (iii) the maximum achieved speed and acceleration for each joint during the desired motion. The control system 112 may then computationally create the static and/or dynamic task-level (or application-level) POE based on the recorded geometry of the machinery. For example, if the motion of the machinery is captured optically using cameras; the control system 112 may utilize a conventional computer-vision program to spatially map the motion of the machinery in the workspace 100 and, based thereon, create the POE of the machinery. In one embodiment, the range of each joint motion is profiled, and a safety-rated soft-axis limiting in joint space by the robot controller can bound the allowable range that each individual axis can move, thereby truncating the POE of the machinery as the maximum and minimum joint position for a particular application. In this case, the safety-rated limits can be enforced by the robot controller, resulting in a controller-initiated protective stop when, for example, (i) the robot position exceeds the safety-rated limits due to robot failure, (ii) an external position-based application profiling is incomplete, (iii) any observations were not properly recorded, and/or (iv) the application itself was changed to encompass a larger volume in the workspace without recharacterization.

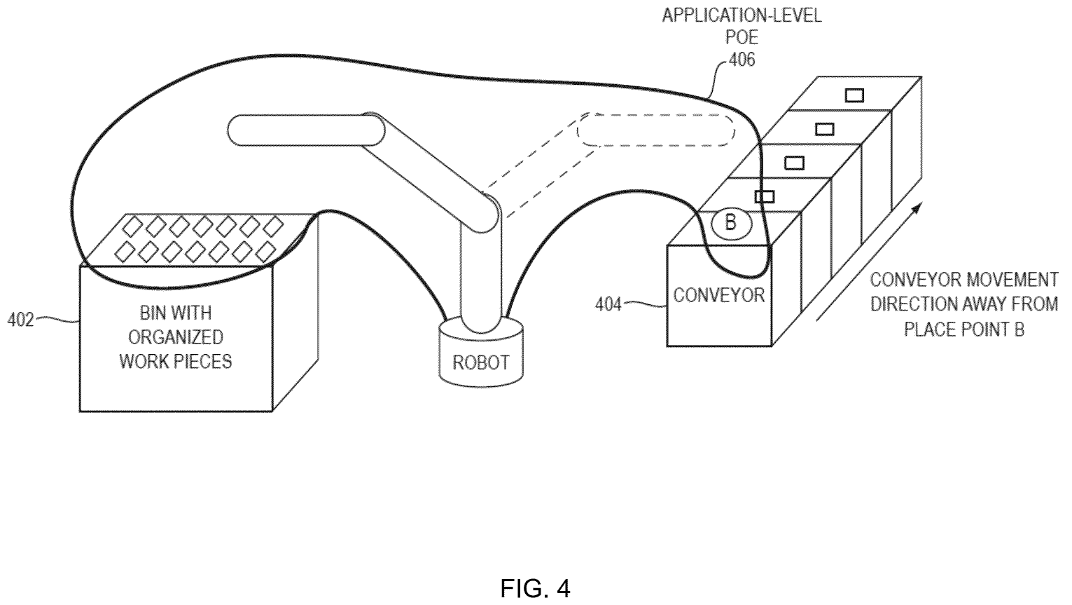

A simple example of the task/application-level POE can be seen in FIG. 4, which illustrates a pick-and-place operation that never changes trajectory between an organized bin 402 of parts (or workpieces) and a repetitive place location, point B, on a conveyor belt 404. This operation can be run continuously, with robot positions read over a statistically significant number of cycles, to determine the range of sensor noise. Incorporation of sensor noise into the computation ensures adequate safety by effectively accounting for the worst-case spatial occupancy given sensor error or imperfections. Based on the programmed robotic trajectory and an additional input characterizing the size of the workpiece, the control system 112 may generate an application-level POE 406.

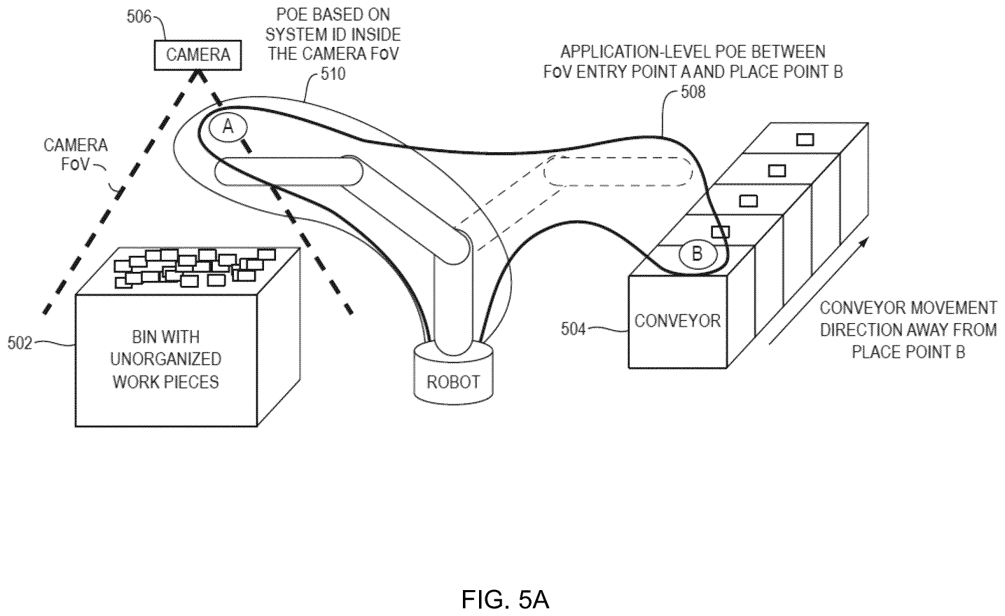

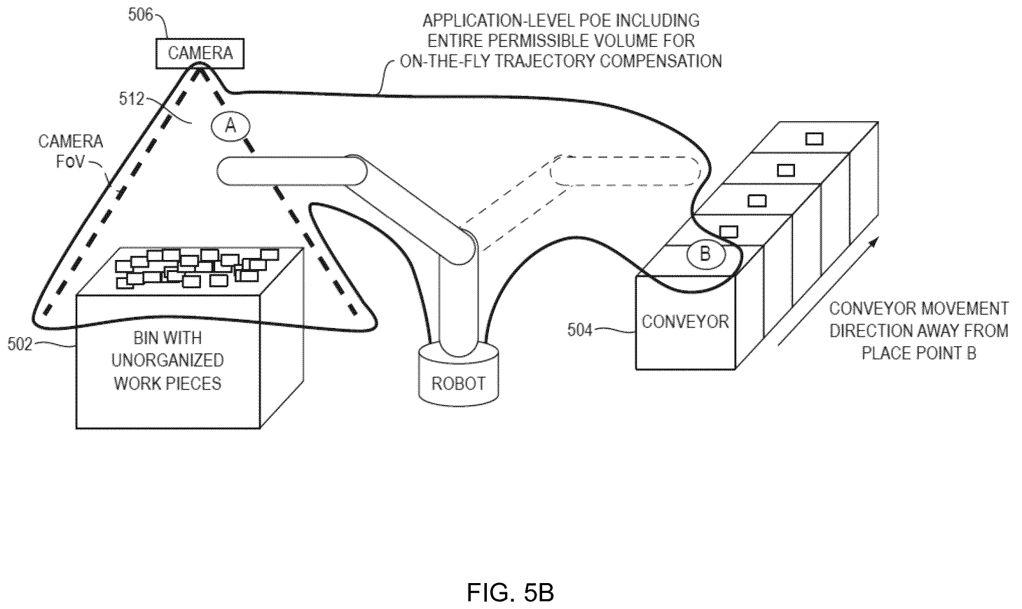

In FIG. 4, there may be no meaningful difference between the static task-level POE and any dynamic POE that may be defined at any point in the execution of the task since the robot trajectory does not change once programmed. But this may change if, for example, the task is altered during execution and/or the robot trajectory is modified by an external device. FIG. 5A depicts an exemplary robotic application that varies the robotic trajectory during operation; as a result, the application-level POE of the robot is updated in real time accordingly. As depicted, the bin 502 may arrive at a robot workstation full of unorganized workpieces in varying orientations. The robot is programmed to pick each workpiece from the bin 502 and place it at point B on a conveyor belt 504. More specifically, the task may be accomplished by mounting a camera 506 above the bin 502 to determine the position and orientation of each workpiece and causing the robot controller to perform on-the-fly trajectory compensation to pick the next workpiece for transfer to the conveyor belt 504. If point A is defined as the location where the robot always enters and exits the camera's field of view (FoV), the static application-level POE 508 between the FoV entry point A and the place point B is identical to the POE 406 shown in FIG. 4. To determine the POE within the camera's view (i.e., upon the robot entering the entry point A), at least two scenarios can be envisioned. FIG. 5A illustrates the first scenario, where upon crossing through FoV entry point A, the calculation of the POE 510 becomes that of a time-bounded dynamic task-level POE—i.e., the POE 510 may be estimated by computing the region that the robot, as it performs the task, may reach from its current position within a predefined time interval. In the second scenario as depicted in FIG. 5B, a bounded region 512, corresponding to the volume within which trajectory compensation is permissible, is added to the characterized application-level POE 508 between FoV entry point A and place point B. As a result, the entire permissible envelope of on-the-fly trajectory compensation is explicitly constrained in computing the static application-level POE.

In various embodiments, the control system 112 facilitates operation of the machinery based on the determined POE thereof. For example, during performance of a task, the sensor system 101 may continuously monitor the position of the machinery, and the control system 112 may compare the actual machinery position to the simulated POE. If a deviation of the actual machinery position from the simulated POE exceeds a predetermined threshold (e.g., 1 meter), the control system 112 may change the pose (position and/or orientation) and/or the velocity (e.g., to a full stop) of the robot for ensuring human safety. Additionally or alternatively, the control system 112 may preemptively change the pose and/or velocity of the robot before the deviation actually exceeds the predetermined threshold. For example, upon determining that the deviation gradually increases and is approaching the predetermined threshold during execution of the task, the control system 112 may preemptively reduce the velocity of the machinery; this may avoid the situation where the inertia of the machinery causes the deviation to exceed the predetermined threshold.

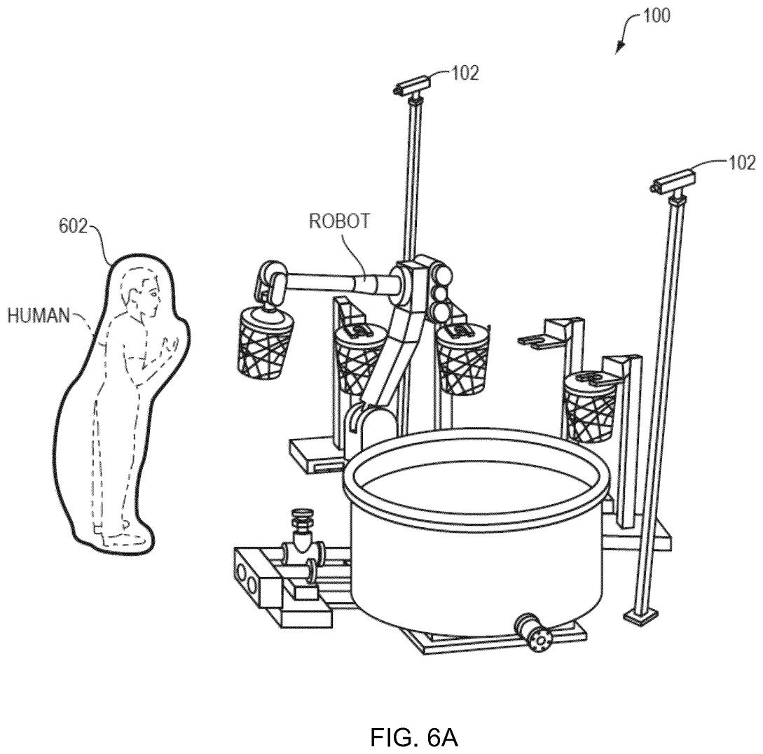

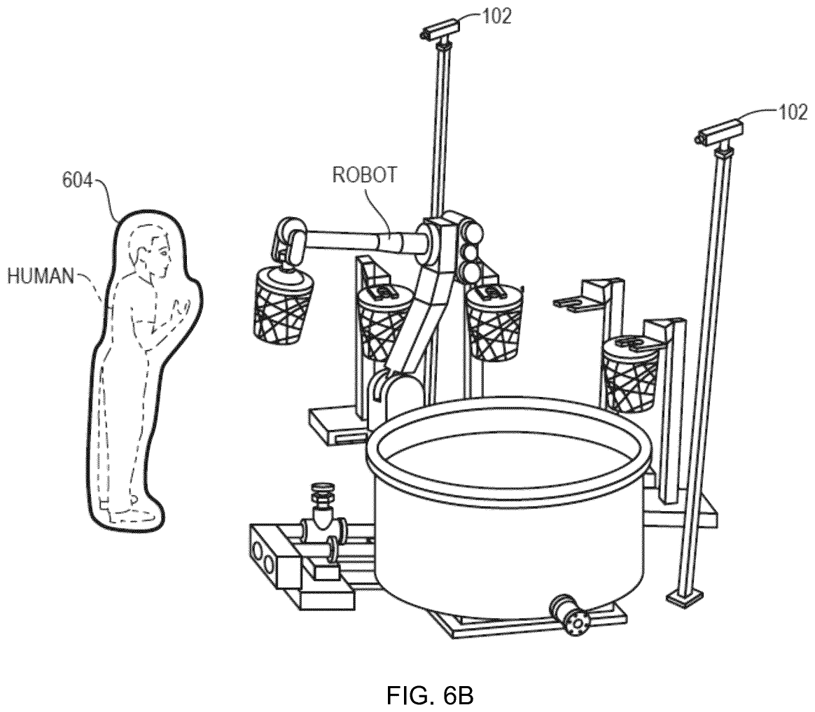

To fully map the workspace 100 in a human-robot collaborative application, it may be desired to consider the presence and movement of the human operator in the vicinity of the machinery. Thus, in various embodiments, a spatial POE of the human operator that characterizes the spatial region potentially occupied by any portion of the human operator is based on any possible or anticipated movements of the human operator within a defined time interval or during performance of a task or an application; this region is computed and mapped in the workspace. As used herein, the term “possible movements” or “anticipated movements” of the human includes a bounded possible location within the defined time interval based, for example, on ISO 13855 standards defining expected human motion in a hazardous setting. To compute/map the POE of the human operator, the control system 112 may first utilize the sensor system 101 to acquire the current position and/or pose of the operator in the workspace 100. In addition, the control system 112 may determine (i) the future position and pose of the operator in the workspace using a well-characterized human model or (ii) all space presently or potentially occupied by any potential operator based on the assumption that the operator can move in any direction at a maximum operator velocity as defined by the standards such as ISO 13855. Again, the operator's position and pose can be treated as a moment frozen in space at the time of image acquisition, and the operator is assumed to be able to move in any direction with any speed and acceleration consistent with the linear and angular kinematics and dynamics of human motion in the immediate future (e.g., in a time interval, δt, after the image-acquisition moment), or at some maximum velocity as defined by the standards. For example, referring to FIG. 6A, a POE 602 that instantaneously characterizes the spatial region potentially occupied by any portion of the human body in the time interval δt can be computed based on the worst-case scenario (e.g., the furthest distance with the fastest speed) that the human operator can move.

In some embodiments, the POE 602 of the human operator is refined by acquiring more information about the operator. For example, the sensor system 101 may acquire a series of scanning data (e.g., images) within a time interval Δt. By analyzing the operator's positions and poses in the scanning data and based on the time period Δt, the operator's moving direction, velocity and acceleration can be determined. This information, in combination with the linear and angular kinematics and dynamics of human motion, may reduce the potential distance reachable by the operator in the immediate future time δt, thereby refining the POE of the operator (e.g., POE 604 in FIG. 6B). This “future-interval POE” for the operator is analogous to the robot-level POE described above.

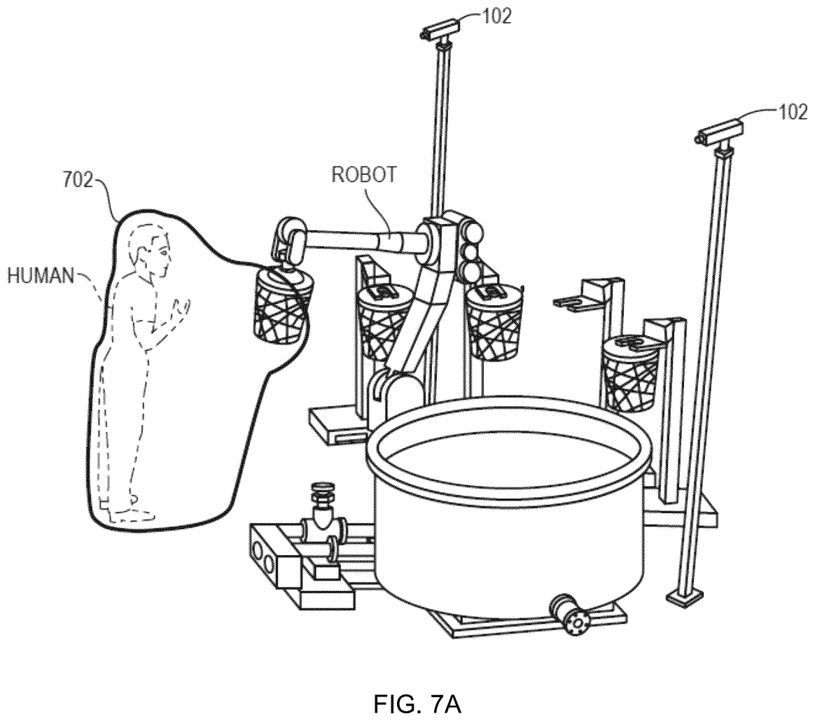

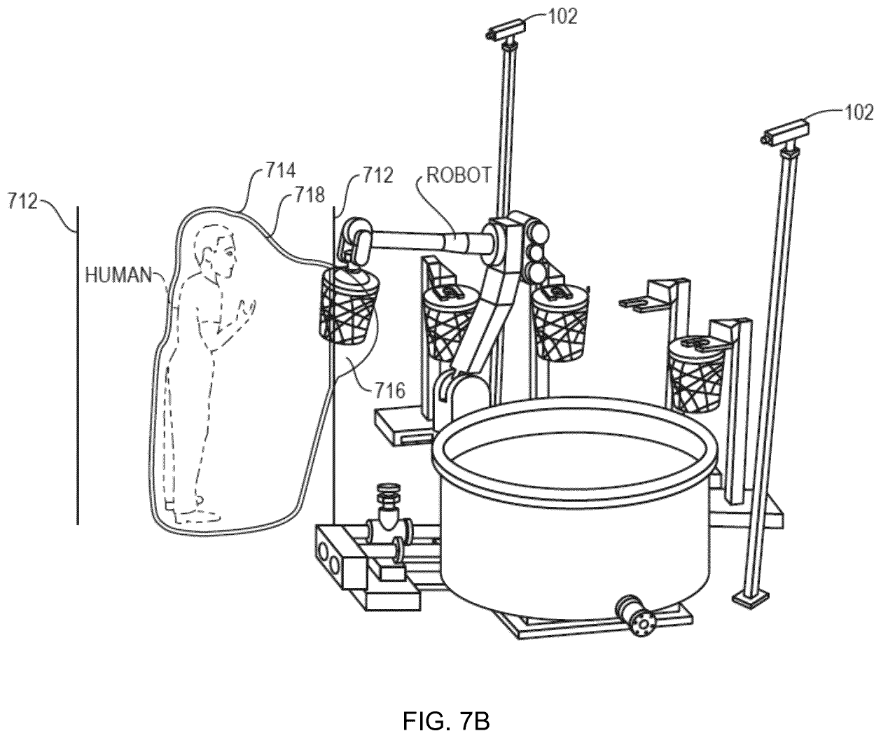

In addition, similar to the POE of the machinery above, the POE of the human operator can be established at an application/task level. For example, referring to FIG. 7, based on the particular task that the operator is required to perform, the location(s) of the resources (e.g., workpieces or equipment) associated with the task, and the linear and angular kinematics and dynamics of human motion, the spatial region that is potentially (or likely) reachable by the operator during performance of the particular task can be computed. The POE 702 of the operator can be defined as the voxels of the spatial region potentially reachable by the operator during performance of the particular task. In some embodiments, the operator may carry a workpiece (e.g., a large but light piece of sheet metal) to an operator-load station for performing the task/application. In this situation, the POE of the operator may be computed by including the geometry of the workpiece, which again, may be acquired by, for example, the sensor system 101.

Further, the POE of the human operator may be truncated based on workspace configuration. For example, referring to FIG. 7B, the workspace may include a physical fence 712 defining the area where the operator can perform a task. Thus, even though the computed POE 714 of the operator indicates that the operator may reach a region 716, the physical fence 712 restricts this movement. As a result, a truncated POE 718 of the operator excluding the region 716 in accordance with the location of the physical fence 712 can be determined. In some embodiments, the workspace includes a turnstile or a type of door that, for example, always allows exit but only permits entry to a collaborative area during certain points of a cycle. Again, based on the location and design of the turnstile/door, the POE of the human operator may be adjusted (e.g., truncated).

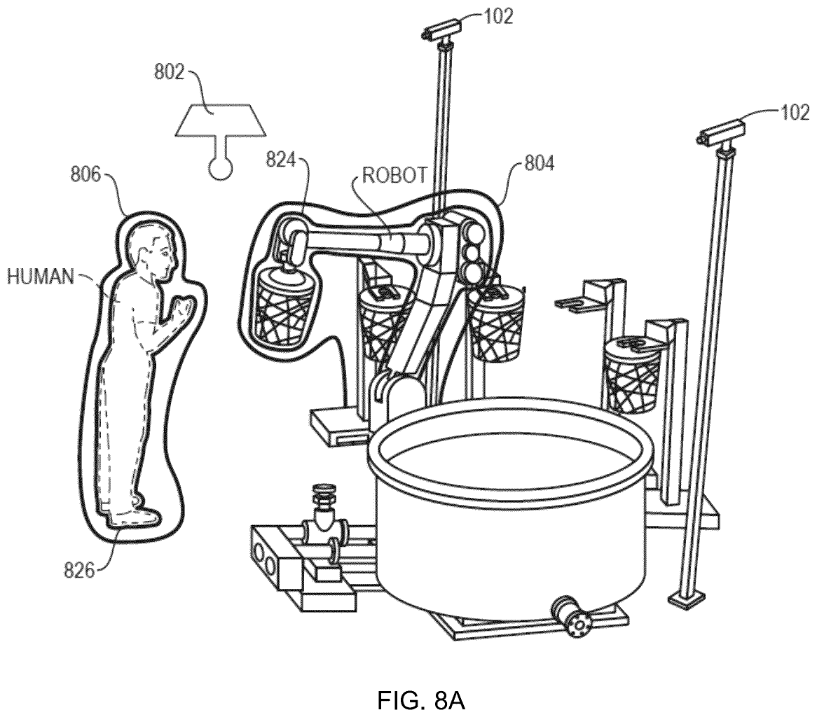

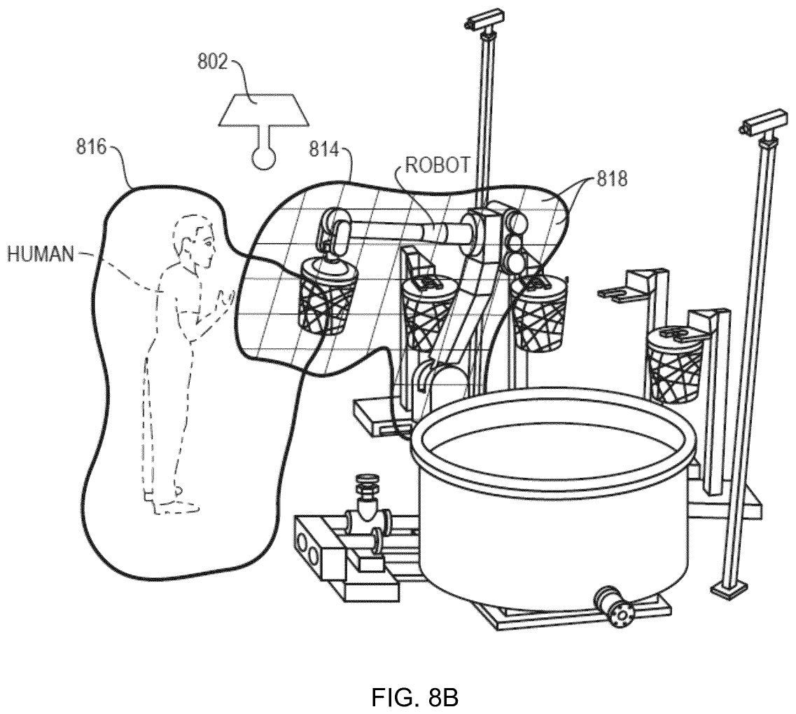

The robot-level POE (and/or application-level POE) of the machinery and/or the future-interval POE (and/or application-level POE) of the human operator may be used to show the operator where to stand and/or what to do during a particular part of the task using suitable indicators (e.g., lights, sounds, displayed visualizations, etc.), and an alert can be raised if the operator unexpectedly leaves the operator POE. In one embodiment, the POEs of the machinery and human operator are both presented on a local display or communicated to a smartphone or tablet application (or other methods, such as augmented reality (AR) or virtual reality (VR)) for display thereon. For example, referring to FIG. 8A, the display 802 may depict the POE 804 of the robot and the POE 806 of the human operator in the immediate future time δt. Alternatively, referring to FIG. 8B, the display 802 may show the largest POE 814 of the robot and the largest POE 816 of the operator during execution of a particular task. In addition, referring again to FIG. 8A, the display 802 may further illustrate the spatial regions 824, 826 that are currently occupied by the robot and operator, respectively; the currently occupied regions 824, 826 may be displayed in a sequential or overlapping manner with the POEs 804 and 806 of the robot and the operator. Displaying the POEs thus allows the human operator to visualize the spatial regions that are currently occupied and will be potentially occupied by the machinery and the operator himself; this may further ensure safety and promote more efficient planning of operator motion based on knowledge of where the machinery will be at what time.

In some embodiments, the machinery is operated based on the POE thereof, the POE of the human operator, and/or a safety protocol that specifies one or more safety measures (e.g., a minimum separation distance or a protective separation distance (PSD) between the machinery and the operator as further described below, a maximum speed of the machinery when in proximity to a human, etc.). For example, during performance of a particular task, the control system 112 may restrict or alter the robot operation based on proximity between the POEs of the robot and the human operator for ensuring that the safety measures in the protocol are satisfied. For example, upon determining that the POEs of the robot and the human operator in the next moment may overlap, the control system 112 may bring the robot to a safe state (e.g., having a reduced speed and/or a different pose), thereby avoiding a contact with the human operator in proximity thereto. The control system 112 may directly control the operation and state of the robot or, alternatively, may send instructions to the robot controller 108 that then controls the robotic operation/state based on the received instructions as further described below.

In addition, the degree of alternation of the robot operation/state may depend on the degree of overlap between the POEs of the robot and the operator. For example, referring again to FIG. 8B, the POE 814 of the robot may be divided into multiple nested, spatially distinct 3D subzones 818; in one embodiment, the more subzones 818 that overlap the POE 816 of the human operator, the larger the degree by which the robot operation/state is altered (e.g., having a larger decrease in the speed or a larger degree of change in the orientation).

In various embodiments, based on the computed robot-level POE 804, future-interval POE 806 of the human operator, or dynamic and/or static application-level POEs 814, 816 of the machinery and human operator for performing a specific action or an entire task, the workspace parameter (such as the dimensions thereof, the workflow, the locations of the resources, etc.) can be modeled to achieve high productivity and spatial efficiency while ensuring safety of the human operator. For example, based on the static task-level POE 814 of the machinery and the largest computed POE 816 of the operator during execution of the task, the minimum dimensions of the workcell can be determined. In addition, the locations and/or orientations of the equipment and/or resources (e.g., the robot, conveyor belt, workpieces) in the workspace can be arranged such that they are easily reachable by the machinery and/or operator while minimizing the overlapped region between the POEs of the machinery and the operator in order to ensure safety. In one embodiment, the computed POEs of the machinery and/or human operator are combined with a conventional spatial modeling tool (e.g., supplied by Delmia Global Operations or Tecnomatix) to model the workspace. For example, the POEs of the machinery and/or human operator may be used as input modules to the conventional spatial modeling tool so as to augment their capabilities to include the human-robot collaboration when designing the workspace and/or workflow of a particular task.

In various embodiments, the dynamic task-level POE of the machinery and/or the task-level POE of the operator is continuously updated during actual execution of the task; such updates can be reflected on the display 802. For example, during execution of the task, the sensor system 101 may periodically scan the machinery, human operator and/or workspace. Based on the scanning data, the poses (e.g., positions and/or orientation) of the machinery and/or human operator can be updated. In addition, by comparing the updated poses with the previous poses of the machinery and/or human operator, the moving directions, velocities and/or accelerations associated with the machinery and operator can be determined. In various embodiments, based on the updated poses, moving directions, velocities and/or accelerations, the POEs of the machinery and operator in the next moment (i.e., after a time increment) can be computed and updated. Additionally, as explained above, the POEs of the machinery and/or human operator may be updated by further taking into account next actions that are specified to be performed in the particular task.

In some embodiments, the continuously updated POEs of the machinery and the human operator are provided as feedback for adjusting the operation of the machinery and/or other setup in the workspace to ensure safety as further described below. For example, when the updated POEs of the machinery and the operator indicate that the operator may be too close to the robot (e.g., a distance smaller than the minimum separation distance defined in the safety protocol), either at present or within a fixed interval (e.g., the robot stopping time), a stop command may be issued to the machinery. In one embodiment, the scanning data of the machinery and/or operator acquired during actual execution of the task is stored in memory and can be used as an input when modeling the workflow of the same human-robot collaborative application in the workspace next time.

In addition, the computed POEs of the machinery and/or human operator may provide insights when determining an optimal path of the machinery for performing a particular task. For example, as further described below, multiple POEs of the operator may be computed based on his/her actions to be performed for the task. Based on the computed POEs of the human operator and the setup (e.g., locations and/or orientations) of the equipment and/or resources in the workspace, the moving path of the machinery in the workspace for performing the task can be optimized so as to maximize the productivity and space efficiency while ensuring safety of the operator.

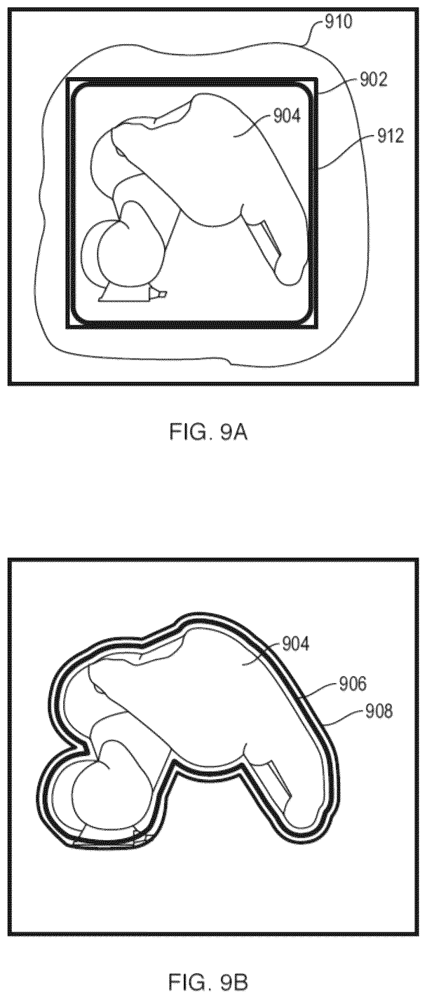

In some embodiments, path optimization includes creation of a 3D “keep-in” zone (or volume) (i.e., a zone/volume to which the robot is restricted during operation) and/or a “keep-out”zone (or volume) (i.e., a zone/volume from which the robot is restricted during operation). Keep-in and keep-out zones restrict robot motion through safe limitations on the possible robot axis positions in Cartesian and/or joint space. Safety limits may be set outside these zones so that, for example, their breach by the robot in operation triggers a stop. Conventionally, robot keep-in zones are defined as prismatic bodies. For example, referring to FIG. 9A, a keep-in zone 902 determined using the conventional approach takes the form of a prismatic volume; the keep-in zone 902 is typically larger than the total swept volume 904 of the machinery during operation (which may be determined either by simulation or characterization using, for example, scanning data acquired by the sensor system 101). Based on the determined keep-in zone 902, the robot controller may implement a position-limiting function to enforce the position limiting of the machinery to be within the keep-in zone 902.

The machinery path determined based on prismatic volumes, however, may not be optimal. In addition, complex robot motions may be difficult to represent as prismatic volumes due to the complex nature of their surfaces and the geometry of the end effectors and workpieces mounted on the robot; as a result, the prismatic volume will be larger than necessary for safety. To overcome this challenge and optimize the moving path of the machinery for performing a task, various embodiments establish and store in memory the swept volume of the machinery (including, for example, robot links, end effectors and workpieces) throughout a programmed routine (e.g., a POE of the machinery), and then define the keep-in zone based on the POE as a detailed volume composed of, e.g., mesh surfaces, NURBS or T-spline solid bodies. That is, the keep-in zone may be arbitrary in shape and not assembled from base prismatic volumes. For example, referring to FIG. 9B, a POE 906 of the machinery may be established by recording the motion of the machinery as it performs the application or task, or alternatively, by a computational simulation defining performance of the task (and the spatial volume within which the task takes place). The keep-in zone 908 defined based on the POE 906 of the machinery thus includes a much smaller region compared to the conventional keep-in zone 902. Because the keep-in zone 908 is tailored based on the specific task/application it executes (as opposed to the prismatic volume offered by conventional modeling tools), a smaller machine footprint can be realized. This may advantageously allow more accurate determination of the optimal path for the machinery when performing a particular task and/or design of a workspace or workflow. In various embodiments, the keep-in zone is enforced by the control system 112, which can transmit instructions to the robot controller to restrict movement of the machinery as further described below. For example, upon detecting that a portion of the machinery is outside (or is predicted to exit) the keep-in zone 908, the control system 112 may issue a stop command to the robot controller, which can then cause the machinery to fully stop.

As described above, the POE of the machinery may be static or dynamic, and may be robot-level or task-level. A static, robot-level POE represents the entire spatial region that the machinery may possibly reach within a specified time, and thus corresponds to the most conservative possible safety zone; a keep-in zone determined based on the static robot-level POE may not be truly a keep-in zone because the machinery's movements are not constrained. If the machinery is stopped or slowed down when a human reaches a prescribed separation distance from any outer point of this zone, the machinery's operation may be curtailed even when intrusions are distant from its near-term reach. A static, task-level POE reduces the volume or distance within which an intrusion will trigger a safety stop or slowdown to a specific task-defined volume and consequently reduces potential robot downtime without compromising human safety. Thus, the keep-in zone determined based on the static, task-level POE of the machinery is smaller than that determined based on the static, robot-level POE. A dynamic, task-level or application-level POE of the machinery may further reduce the POE (and thereby the keep-in zone) based on a specific point in the execution of a task by the machinery. A dynamic task-level POE achieves the smallest sacrifice of productive robot activity while respecting safety guidelines.

Alternatively, the keep-in zone may be defined based on the boundary of the total swept volume 904 of the machinery during operation or slight padding/offset of the total swept volume 904 to account for measurement or simulation error. This approach may be utilized when, for example, the computed POE of the machinery is sufficiently large. For example, referring again to FIG. 9A, the computed POE 910 of the machinery may be larger than the keep-in zone 902. But because the machinery cannot move outside the keep-in zone 902, the POE 910 has to be truncated based on the prismatic geometry of the keep-in zone 902. The truncated POE 912, however, also involves a prismatic volume, so determining the machinery path based thereon may thus not be optimal. In contrast, referring again to FIG. 9B, the POE 906 truncated based on the application/task-specific keep-in zone 908 may include a smaller volume that is tailored to the application/task being executed; thereby allowing more accurate determination of the optimal path for the machinery and/or design of a workspace or workflow.

In various embodiments, the actual or potential movement of the human operator is evaluated against the robot-level or application-level POE of the machinery to define the keep-in zone. Expected human speeds in industrial environments are referenced in ISO 13855:2010, ISO 61496-1:2012 and ISO 10218:2011. For example, human bodies are expected to move no faster than 1.6 m/s and human extremities are expected to move no faster than 2 m/s. In one embodiment, the points reachable by the human operator in a given unit of time is approximated by a volume surrounding the operator, which can define the human POE as described above. If the human operator is moving, the human POE moves with her. Thus, as the human POE approaches the task-level POE of the robot, the latter may be reduced in dimension along the direction of human travel to preserve a safe separation distance. In one embodiment, this reduced task-level POE of the robot (which varies dynamically based on the tracked and/or estimated movement of the operator) is defined as a keep-in zone. So long as the robot can continue performing elements of the task within the smaller (and potentially shrinking) POE (i.e., keep-in zone), the robot can continue to operate productively; otherwise, it may stop. Alternatively, the dynamic task-level POE of the machinery may be reduced in response to an advancing human by slowing down the machinery as further described below. This permits the machinery to keep working at a slower rate rather than stopping completely. Moreover, slower machinery movement may in itself pose a lower safety risk.

In various embodiments, the keep-in and keep-out zones are implemented in the machinery having separate safety-rated and non-safety-rated control systems, typically in compliance with an industrial safety standard. Safety architectures and safety ratings are described, for example, in U.S. Ser. No. 16/800,429, entitled “System architecture for safety applications,” filed on Feb. 25, 2020, now U.S. Pat. No. 11,543,798, the entire contents of which are hereby incorporated by reference. Non-safety-rated systems, by contrast, are not designed for integration into safety systems (e.g., in accordance with the safety standard).

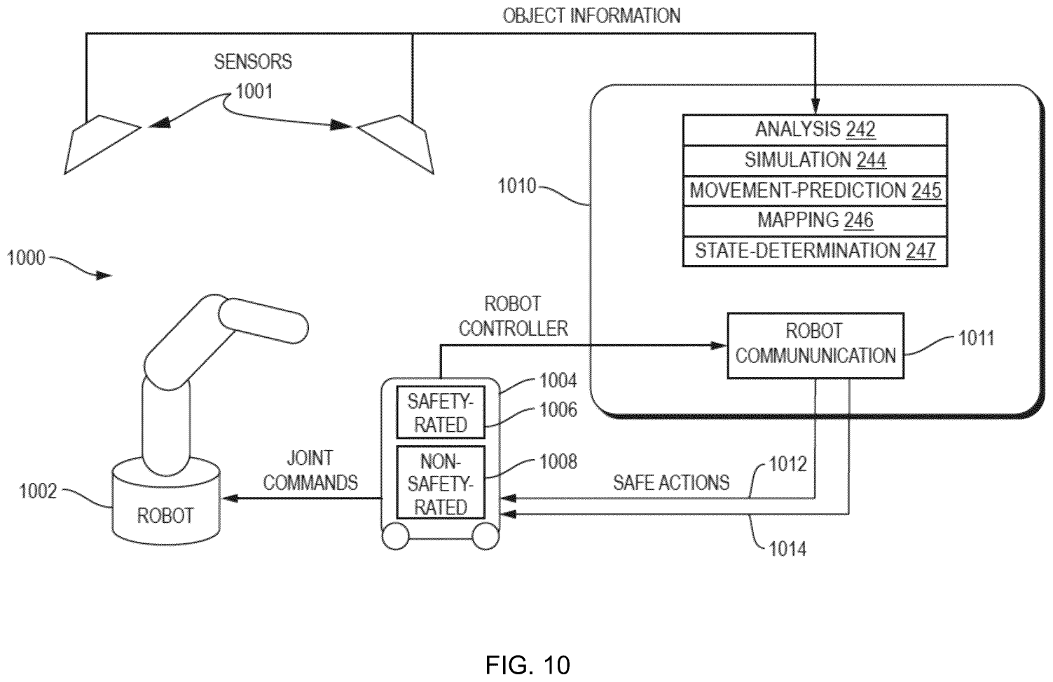

Operation of the safety-rated and non-safety-rated control systems is best understood with reference to the conceptual illustration of system organization and operation of FIG. 10. As described above, a sensor system 1001 monitors the workspace 1000, which includes the machinery (e.g., a robot) 1002. Movements of the machinery are controlled by a conventional robot controller 1004, which may be part of or separate from the robot itself; for example, a single robot controller may issue commands to more than one robot. The robot's activities may primarily involve a robot arm, the movements of which are orchestrated by the robot controller 1004 using joint commands that operate the robot arm joints to effect a desired movement. In various embodiments, the robot controller 1004 includes a safety-rated component (e.g., a functional safety unit) 1006 and a non-safety-rated component 1008. The safety-rated component 1006 may enforce the robot's state (e.g., position, orientation, speed, etc.) such that the robot is operated in a safe manner. The safety-rated component 1006 typically incorporates a closed control loop together with the electronics and hardware associated with machine control inputs. The non-safety-rated component 1008 may be controlled externally to change the robot's state (e.g., slow down or stop the robot) but not in a safe manner—i.e., the non-safety-rated component cannot be guaranteed to change the robot's state, such as slowing down or stopping the robot, within a determined period of time for ensuring safety. In one embodiment, the non-safety-rated component 1008 contains the task-level programming that causes the robot to perform an application. The safety-rated component 1006, by contrast, may perform only a monitoring function, i.e., it does not govern the robot motion—instead, it only monitors positions and velocities (e.g., based on the machine state maintained by the non-safety-rated component 1008) and issues commands to safely slow down or stop the robot if the robot's position or velocity strays outside predetermined limits. Commands from the safety-rated monitoring component 1006 may override robot movements dictated by the task-level programming or other non-safety-rated control commands.

Typically, the robot controller 1004 itself does not have a safe way to govern (e.g., modify) the state (e.g., speed, position, etc.) of the robot; rather, it only has a safe way to enforce a given state. To govern and enforce the state of the robot in a safe manner, in various embodiments, an object-monitoring system (OMS) 1010 is implemented to cooperatively work with the safety-rated component 1006 and non-safety-rated component 1008 as further described below. In one embodiment, the OMS 1010 obtains information about objects from the sensor system 1001 and uses this sensor information to identify relevant objects in the workspace 1000. For example, OMS 1010 may, based on the information obtained from the sensor system (and/or the robot), monitor whether the robot is in a safe state (e.g., remains within a specific zone (e.g., the keep-in zone), stays below a specified speed, etc.), and if not, issues a safe-action command (e.g., stop) to the robot controller 1004.

For example, OMS 1010 may determine the current state of the robot and/or the human operator and computationally generate a POE for the robot and/or a POE for the human operator when performing a task in the workspace 1000. The POEs of the robot and/or human operator may then be transferred to the safety-rated component for use as a keep-in zone as described above. Alternatively, the POEs of the robot and/or human operator may be shared by the safety-rated and non-safety-rated control components of the robot controller. OMS 1010 may transmit the POEs and/or safe-action constraints to the robot controller 1004 via any suitable wired or wireless protocol. (In an industrial robot, control electronics typically reside in an external control box. However, in the case of a robot with a built-in controller, OMS 1010 communicates directly with the robot's onboard controller.) In various embodiments, OMS 1010 includes a robot communication module 1011 that communicates with the safety-rated component 1006 and non-safety-rated component 1008 via a safety-rated channel (e.g., digital I/O) 1012 and a non-safety-rated channel (e.g., an Ethernet connector) 1014, respectively. In addition, when the robot violates the safety measures specified in the safety protocol, OMS 1010 may issue commands to the robot controller 1004 via both the safety-rated and non-safety-rated channels. For example, upon determining that the robot speed exceeds a predetermined maximum speed when in proximity to the human (or the robot is outside the keep-in zone or the PSD exceeds the predetermined threshold), OMS 1010 may first issue a command to the non-safety-rated component 1008 via the non-safety-rated channel 1014 to reduce the robot speed to a desired value (e.g., below or at the maximum speed), thereby reducing the dynamic POE of the robot. This action, however, is non-safety-rated. Thus, after the robot speed is reduced to the desired value (or the dynamic POE of the robot is reduced to the desired size), OMS 1010 may issue another command to the safety-rated component 1008 via the safety-rated channel 1012 such that the safety-rated component 1008 can enforce a new robot speed, which is generally higher than the reduced robot speed (or a new keep-in zone based on the reduced dynamic POE of the robot). Accordingly, various embodiments effectively “safety rate” the function provided by the non-safety-rated component 1008 by causing the non-safety-rated component 1008 to first reduce the speed or dynamic POE of the robot in spatial extent in an unsafe way, and then engaging the safety-rated (e.g., monitoring) component to ensure that the robot remains in the now-reduced speed (or, within the now-reduced POE, as a new keep-in zone). Similar approaches can be implemented to increase the speed or POE of the robot in a safe manner during performance of the task. (It will be appreciated that, with reference to FIG. 2, the functions of OMS 1010 described above are performed in a control system 112 by analysis module 242, simulation module 244, movement-prediction module 245, mapping module 246, state determination module 247 and, in some cases, the control routines 252.)

Similarly, the keep-out zone may be determined based on the POE of the human operator. Again, a static future-interval POE represents the entire spatial region that the human operator may possibly reach within a specified time, and thus corresponds to the most conservative possible keep-out zone within which an intrusion of the robot will trigger a safety stop or slowdown. A static task-level POE of the human operator may reduce the determined keep-out zone in accordance with the task to be performed, and a dynamic, task-level or application-level POE of the human may further reduce the keep-out zone based on a specific point in the execution of a task by the human. In addition, the POE of the human operator can be shared by the safety-rated and non-safety-rated control components as described above for operating the robot in a safe manner. For example, upon detecting intrusion of the robot in the keep-out zone, the OMS 1010 may issue a command to the non-safety-rated control component to slow down the robot in an unsafe way, and then engaging the safety-rated robot control (e.g., monitoring) component to ensure that the robot remains outside the keep-out zone or has a speed below the predetermined value.

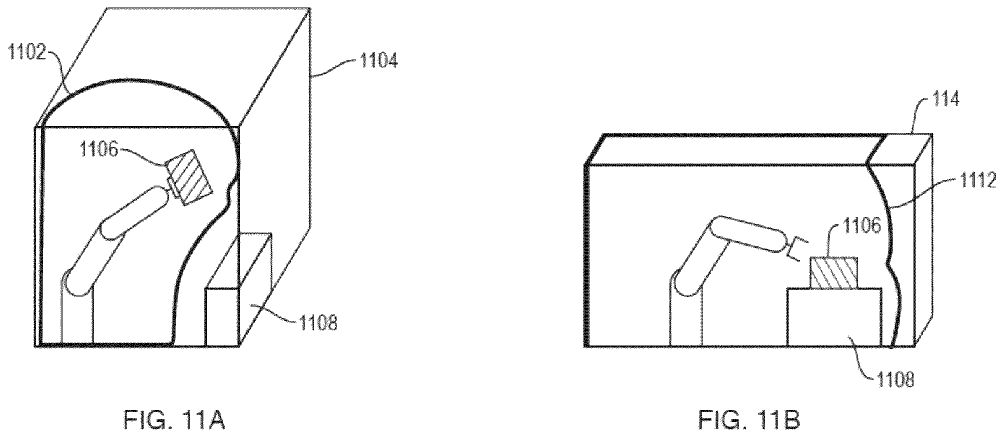

Once the keep-in zone and/or keep-out zone are defined, the machinery is safely constrained within the keep-in zone, or prevented from entering the keep-out zone, reducing the POE of the machinery as discussed above. Further, path optimization may include dynamic changing or switching of zones throughout the task, creating multiple POEs of different sizes, in a similar way as described for the operator. Moreover, switching of these dynamic zones may be triggered not only by a priori knowledge of the machinery program as described above, but also by the instantaneous detected location of the machinery or the human operator. For example, if a robot is tasked to pick up a part, bring it to a fixture, then perform a machining operation on the part, the POE of the robot can be dynamically updated based on safety-rated axis limiting at different times within the program. FIGS. 11A and 11B illustrate this scenario. FIG. 11A depicts the robot POE 1102 truncated by a large keep-in zone 1104, allowing the robot to pick up a part 1106 and bring it to a fixture 1108. Upon placement of the part 1106 in the fixture 1108 and while the robot is performing a machining task on the part 1106, as shown in FIG. 11B, the keep-in zone 1114 is dynamically switched to a smaller state, further truncating the POE 1112 during this part of the robot program.

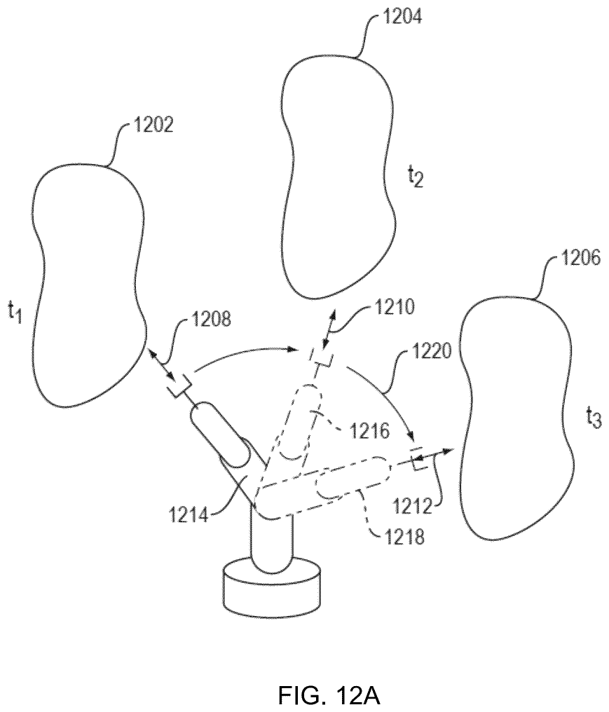

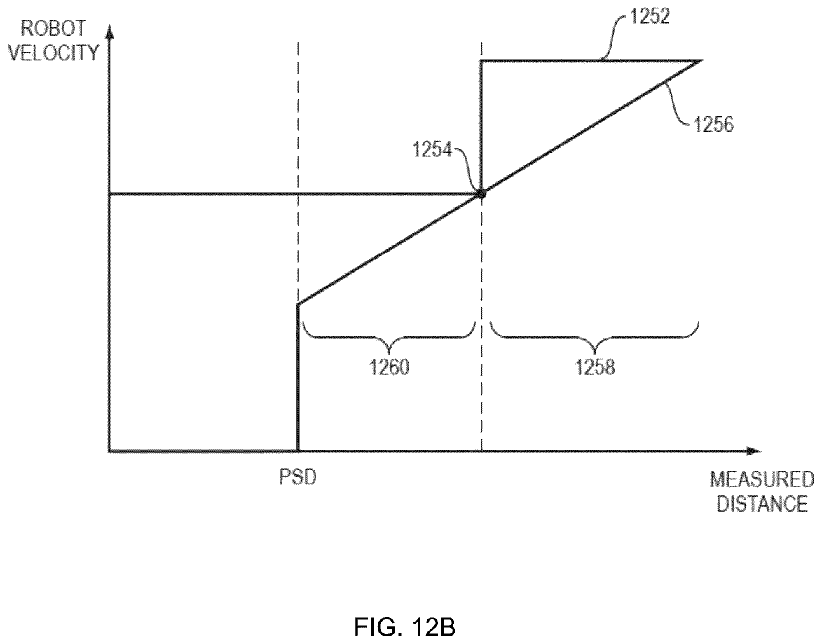

Additionally or alternatively, once the machinery's current state (e.g., payload, position, orientation, velocity and/or acceleration) is acquired, a PSD (generally defined as the minimum distance separating the machinery from the operator for ensuring safety) and/or other safety-related measures can be computed. For example, the PSD may be computed based on the POEs of the machinery and the human operator as well as any keep-in and/or keep-out zones. Again, because the machinery's state may change during execution of the task, the PSD may be continuously updated throughout the task as well. This can be achieved by, for example, using the sensor system 101 to periodically acquire the updated state of the machinery and the operator, and, based thereon, updating the PSD. In addition, the updated PSD may be compared to a predetermined threshold; if the updated PSD is smaller than the threshold, the control system 112 may adjust (e.g., reduce), for example, the speed of the machinery as further described below so as to bring the robot to a safe state. In various embodiments, the computed PSD is combined with the POE of the human operator to determine the optimal speed or robot path (or choosing among possible paths) for executing a task. For example, referring to FIG. 12A, the envelopes 1202-1206 represent the largest POEs of the operator at three instants, t₁₋₃, respectively, during execution of a human-robot collaborative application; based on the computed PSDs 1208-1212, the robot's locations 1214-1218 that can be closest to the operator at the instants t₁-t₃, respectively, during performance of the task (while avoiding safety hazards) can be determined. As a result, an optimal path 1220 for the robot movement including the instants t₁-t₃ can be determined. Alternatively, instead of determining the unconstrained optimal path, the POE and PSD information can be used to select among allowed or predetermined paths given programmed or environmental constraints—i.e., identifying the path alternative that provides greatest efficiency without violating safety constraints.

In various embodiments, the computed PSD is utilized to govern the speed (or other states) of the machinery; this may be implemented in, for example, an application where the machinery path cannot deviate from its original programmed trajectory. In this case, the PSD between the POEs of the human and the machinery is dynamically computed during performance of the task and continuously compared to the instantaneous measured distance between the human and the machinery (using, e.g., the sensor system 101). However, instead of a system that alters the path of the machinery, or simply initiates a protective stop when the PSD is violated, the control system 112 may govern (e.g., modify) the current speed of the machinery to a lower set point at a distance larger than the PSD. At the instant when the machinery reaches the lower set point, not only will the POE of the machinery be smaller, but the distance that the operator is from the new POE of the machinery will be larger, thereby ensuring safety of the human operator. FIG. 12B depicts this scenario. Line 1252 represents a safety-rated joint monitor, corresponding to a velocity at which an emergency stop is initiated at point 1254. In this example, line 1252 corresponds to the velocity used to compute the size of the machinery's POE. Line 1256 corresponds to the commanded (and actual) speed of the machinery. As the measured distance between the POEs of the machinery and human operator decreases, the commanded speed of the machinery may decrease accordingly, but the size of the machinery's POE does not change (e.g., in region 1258). Once the machinery has slowed down to the particular set point 1254 (at a distance larger than the PSD), the velocity at which the safety-rated joint monitor may trigger an emergency stop can be decreased in a stepwise manner to shrink the POE of the machinery (e.g., in region 1260). The decreased POE of the machinery (corresponding to a decreased PSD) may allow the operator to work in closer proximity to the machinery in a safety-compliant manner. In one embodiment, governing to the lower set point is achieved using a precomputed safety function that is already present in the robot controller or, alternatively, using a safety-rated monitor paired with a non-safety governor.

Further, the spatial mapping described herein (e.g., the POEs of the machinery and human operator and/or the keep-in/keep-out zone) may be combined with enhanced robot control as described in U.S. Pat. No. 10,099,372 (“'372 patent”), the entire disclosure of which is hereby incorporated by reference. The '372 patent considers dynamic environments in which objects and people come, go, and change position; hence, safe actions are calculated by a safe-action determination module (SADM) in real time based on all sensed relevant objects and on the current state of the robot, and these safe actions may be updated each cycle so as to ensure that the robot does not collide with the human operator and/or any stationary object.

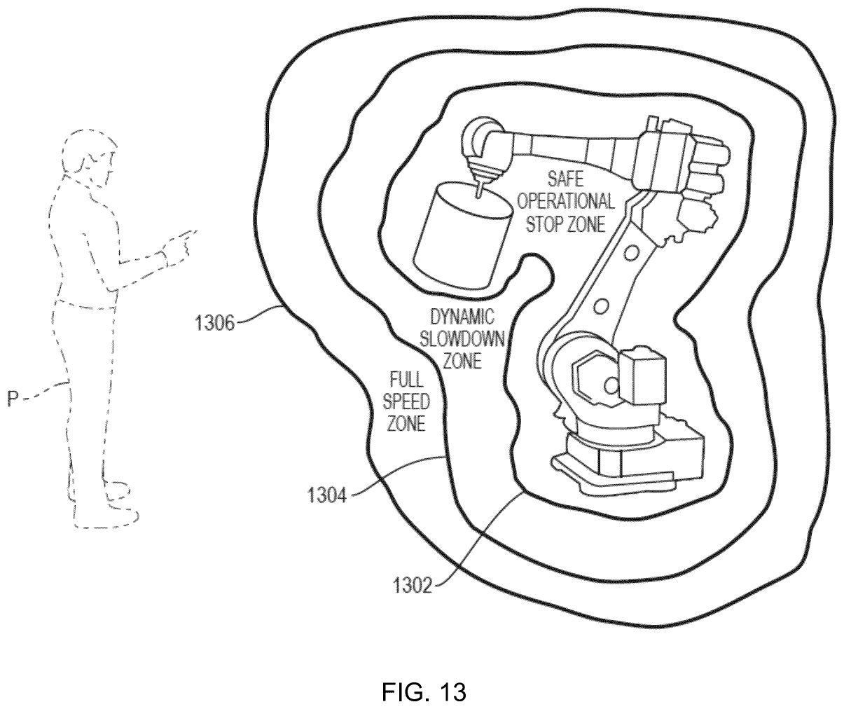

One approach to achieving this is to modulate the robot's maximum velocity (by which is meant the velocity of the robot itself or any appendage thereof) proportionally to the minimum distance between any point on the robot and any point in the relevant set of sensed objects to be avoided. For example, the robot may be allowed to operate at maximum speed when the closest object or human is further away than some threshold distance beyond which collisions are not a concern, and the robot is halted altogether if an object/human is within the PSD. For example, referring to FIG. 13, an interior 3D danger zone 1302 around the robot may be computationally generated by the SADM based on the computed PSD or keep-in zone associated with the robot described above; if any portion of the human operator crosses into the danger zone 1302—or is predicted to do so within the next cycle based on the computed POE of the human operator—operation of the robot may be halted. In addition, a second 3D zone 1304 enclosing and slightly larger than the danger zone 1302 may be defined also based on the computed PSD or keep-in zone associated with the robot. If any portion of the human operator crosses the threshold of zone 1304 but is still outside the interior danger zone 1302, the robot is signaled to operate at a slower speed. In one embodiment, the robot is proactively slowed down when the future interval POE of the operator overlaps spatially with the second zone 1304 such that the next future interval POE cannot possibly enter the danger zone 1302. Further, an outer zone 1306 corresponding to a boundary may be defined such that outside this zone 1306, all movements of the human operator are considered safe because, within an operational cycle, they cannot bring the operator sufficiently close to the robot to pose a danger. In one embodiment, detection of any portion of the operator's body within the outer zone 1306 but still outside the second 3D zone 1304 allows the robot 904 to continue operating at full speed. These zones 1302-1306 may be updated if the robot is moved (or moves) within the environment and may complement the POE in terms of overall robot control.

In various embodiments, sufficient margin can be added to each of the zones 1302-1306 to account for movement of relevant objects or humans toward the robot at some maximum realistic velocity. Additionally or alternatively, state estimation techniques based on information detected by the sensor system 101 can be used to project the movements of the human and other objects forward in time. For example, skeletal tracking techniques can be used to identify moving limbs of humans that have been detected and limit potential collisions based on properties of the human body and estimated movements of, e.g., a person's arm rather than the entire person. The robot can then be operated based on the progressive safety zones 1302-1306 and the projected movements of the human and other objects.

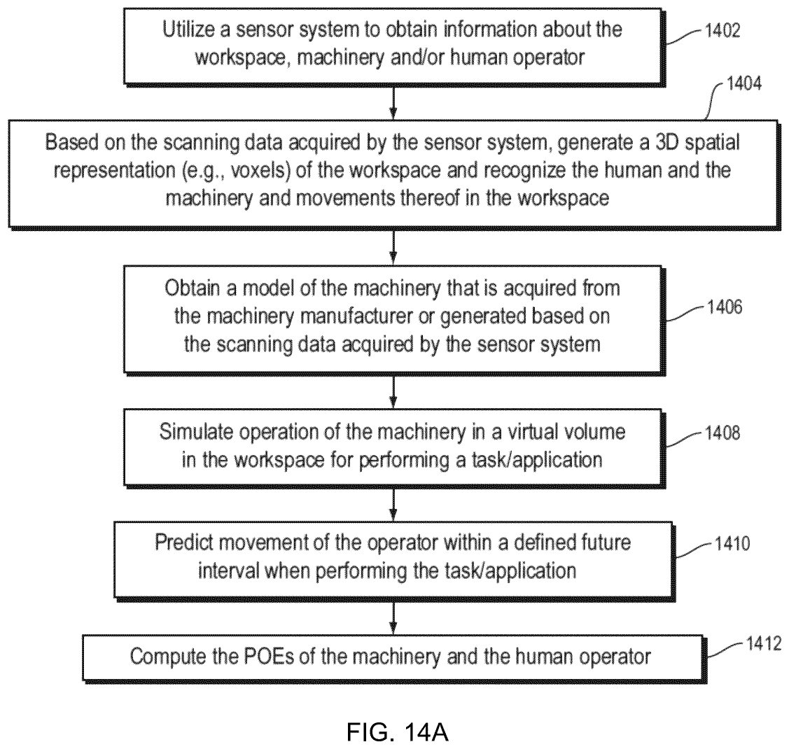

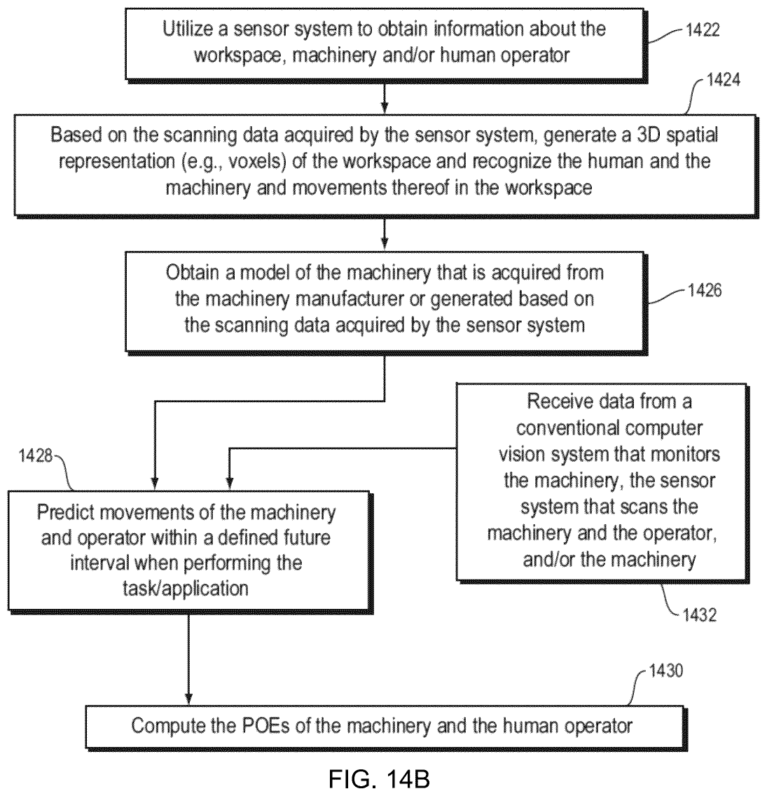

FIG. 14A illustrates an exemplary approach for computing a POE of the machinery and/or human operator based at least in part on simulation of the machinery's operation in accordance herewith. In a first step 1402, the sensor system is activated to acquire information about the workspace, machinery and/or human operator. In a second step 1404, based on the scanning data acquired by the sensor system, the control system generates a 3D spatial representation (e.g., voxels) of the workspace (e.g., using the analysis module 242) and recognize the human and the machinery and movements thereof in the workspace (e.g., using the object-recognition module 243). In a third step 1406, the control system accesses the system memory to retrieve a model of the machinery that is acquired from the machinery manufacturer (or the conventional modeling tool) or generated based on the scanning data acquired by the sensor system. In a fourth step 1408, the control system (e.g., the simulation module 244) simulates operation of the machinery in a virtual volume in the workspace for performing a task/application. The simulation module 244 typically receives parameters characterizing the geometry and kinematics of the machinery (e.g., based on the machinery model) and is programmed with the task that the machinery is to perform; that task may also be programmed in the machinery (e.g., robot) controller. In one embodiment, the simulation result is then transmitted to the mapping module 246. (The division of responsibility between the modules 244, 246 is one possible design choice.) In addition, the control system (e.g., the movement-prediction module 245) may predict movement of the operator within a defined future interval when performing the task/application (step 1410). The movement prediction module 245 may utilize the current state of the operator and identification parameters characterizing the geometry and kinematics of the operator to predict all possible spatial regions that may be occupied by any portion of the human operator within the defined interval when performing the task/application. This data may then be passed to the mapping module 246, and once again, the division of responsibility between the modules 245, 246 is one possible design choice. Based on the simulation results and the predicted movement of the operator, the mapping module 246 creates spatial maps (e.g., POEs) of points within a workspace that may potentially be occupied by the machinery and the human operator (step 1412).

FIG. 14B illustrates an exemplary approach for computing dynamic POEs of the machinery and/or human operator when executing a task/application in accordance herewith. In a first step 1422, the sensor system is activated to acquire information about the workspace, machinery and/or human operator. In a second step 1424, based on the scanning data acquired by the sensor system, the control system generates a 3D spatial representation (e.g., voxels) of the workspace (e.g., using the analysis module 242) and recognizes the human and the machinery and movements thereof in the workspace (e.g., using the object-recognition module 243). In a third step 1426, the control system accesses system memory to retrieve a model of the machinery acquired from the machinery manufacturer (or a conventional modeling tool) or generated based on the scanning data acquired by the sensor system. In a fourth step 1428, the control system (e.g., the movement-prediction module 245) predicts movements of the machinery and/or operator within a defined future interval when performing the task/application. For example, the movement-prediction module 245 may utilize the current states of the machinery and the operator and identification parameters characterizing the geometry and kinematics of the machinery (e.g., based on the machinery model) and the operator to predict all possible spatial regions that may be occupied by any portion of the machinery and any portion of the human operator within the defined interval when performing the task/application. In a fifth step 1430, based on the predicted movements of the machinery and the operator, the mapping module 246 creates the POEs of the machinery and the human operator.

In one embodiment, the mapping module 246 can receive data from a conventional computer vision system that monitors the machinery, the sensor system that scans the machinery and the operator, and/or the robot (e.g., joint position data, keep-in zones and/or or intended trajectory), in step 1432. The computer vision system utilizes the sensor system to track movements of the machinery and the operator during physical execution of the task. The computer vision system is calibrated to the coordinate reference frame of the workspace and transmits to the mapping module 246 coordinate data corresponding to the movements of the machinery and the operator. In various embodiments, the tracking data is then provided to the movement-prediction module 245 for predicting the movements of the machinery and the operator in the next time interval (step 1428). Subsequently, the mapping module 246 transforms this prediction data into voxel-level representations to produce the POEs of the machinery and the operator in the next time interval (step 1430). Steps 1428-1432 may be iteratively performed during execution of the task.

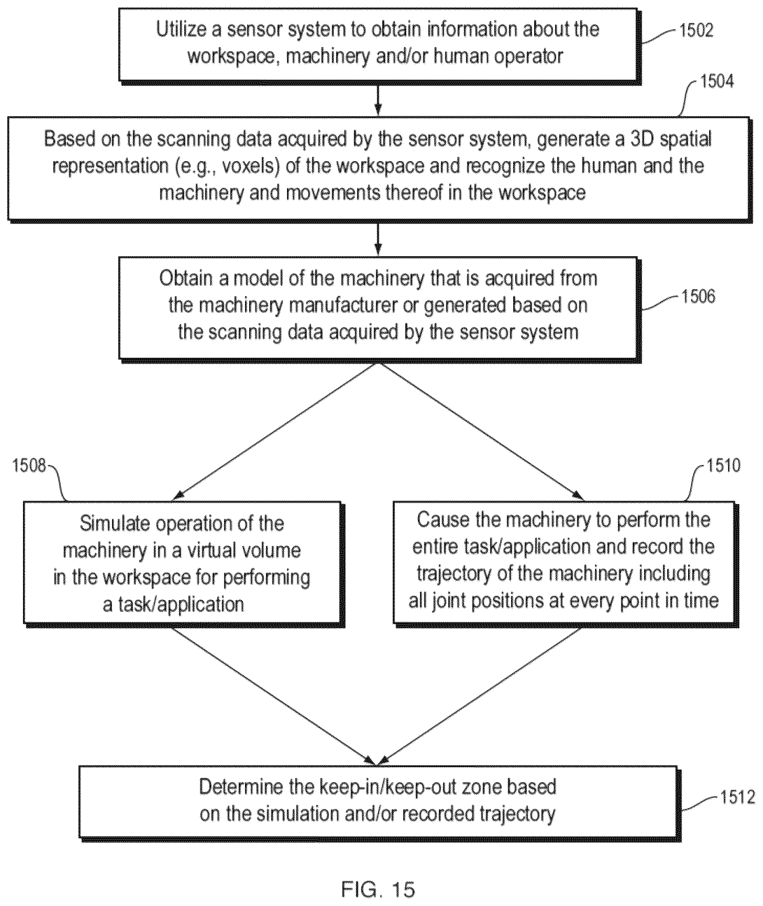

FIG. 15 illustrates an exemplary approach for determining a keep-in zone and/or a keep-out zone in accordance herewith. In a first step 1502, the sensor system is activated to acquire information about the workspace, machinery and/or human operator. In a second step 1504, based on the scanning data acquired by the sensor system, the control system generates a 3D spatial representation (e.g., voxels) of the workspace (e.g., using the analysis module 242) and recognize the human and the machinery and movements thereof in the workspace (e.g., using the object-recognition module 243). In a third step 1506, the control system accesses system memory to retrieve a model of the machinery acquired from the machinery manufacturer (or the conventional modeling tool) or generated based on the scanning data acquired by the sensor system. In a fourth step 1508, the control system (e.g., the simulation module 244) simulates operation of the machinery in a virtual volume in the workspace in performing a task/application. Additionally or alternatively, the control system may cause the machinery to perform the entire task/application and record the trajectory of the machinery including all joint positions at every point in time (step 1510). Based on the simulation results and/or the recording data, the mapping module 246 determines the keep-in zone and/or keep-out zone associated with the machinery (step 1512). To achieve this, in one embodiment, the mapping module 246 first computes the POEs of the machinery and the human operator based on the simulation results and/or the recording data and then determines the keep-in zone and keep-out zone based on the POEs of the machinery and the POE of the operator, respectively.

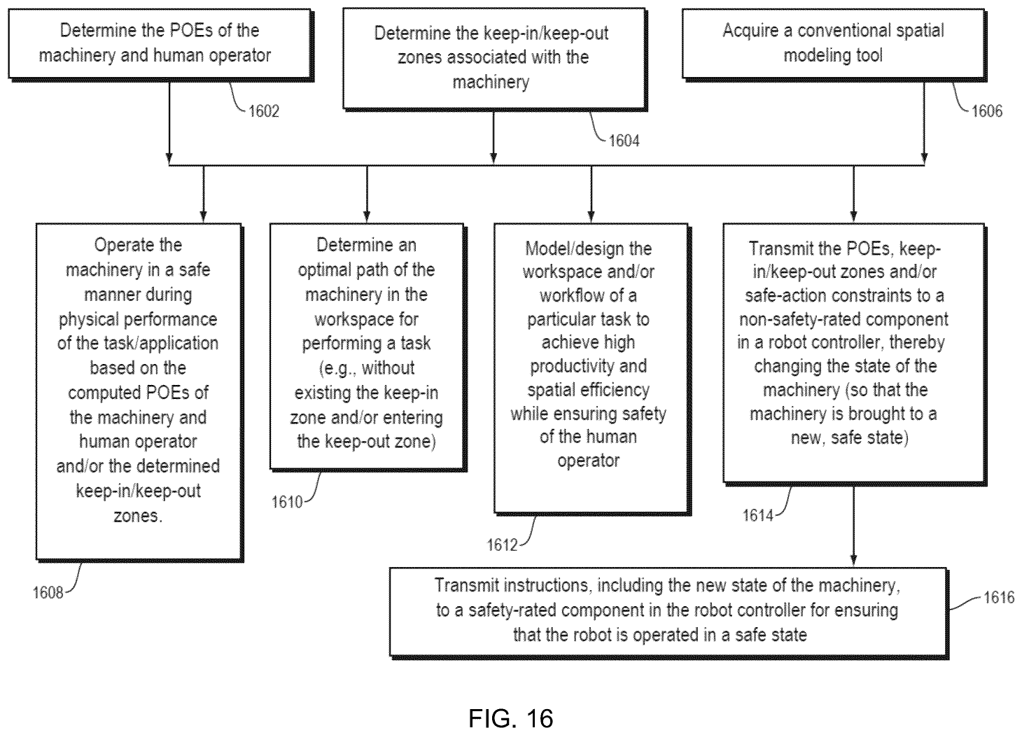

FIG. 16 depicts approaches to performing various functions (such as enforcing safe operation of the machinery when performing a task in the workspace, determining an optimal path of the machinery in the workspace for performing the task, and modeling/designing the workspace and/or workflow of the task) in different applications based on the computed POEs of the machinery and human operator and/or the keep-in/keep-out zones in accordance herewith. In a first step 1602, the POEs of the machinery and human operator are determined using the approaches described above (e.g., FIGS. 14A and 14B). Additionally or alternatively, in a step 1608, information about the keep-in/keep-out zones associated with the machinery may be acquired from the robot controller and/or determined using the approaches described above (e.g., FIG. 15). In one embodiment, a conventional spatial modeling tool (e.g., supplied by Delmia Global Operations or Tecnomatix) is optionally acquired (step 1606). Based on the computed POEs of the machinery and human operator and/or keep-in/keep-out zones, the machinery may be operated in a safe manner during physical performance of the task/application as described above (step 1608). For example, the simulation module 244 may compute a degree of proximity between the POEs of the machinery and human operator (e.g., the PSD), and then the state-determination module 247 may determine the state (e.g., position, orientation, velocity, acceleration, etc.) of the machinery such that the machinery can be operated in a safe state; subsequently, the control system may transmit the determined state to the robot controller to cause and ensure the machinery to be operated in a safe state.

Additionally or alternatively, the control system (e.g., the path-determination module 248) may determine an optimal path of the machinery in the workspace for performing the task (e.g., without exiting the keep-in zone and/or entering the keep-out zone) based on the computed POEs of the machinery and human operator and/or keep-in/keep-out zones (e.g., by communicating them to a CAD system) and/or utilizing the conventional spatial modeling tool (step 1610). In some embodiments, the control system (e.g., the workspace-modeling module 249) computationally models the workspace parameter (e.g., the dimensions, workflow, locations of the equipment and/or resources) based on the computed POEs of the machinery and the human operator and/or the keep-in/keep-out zone (e.g., by communicating them to a CAD system) and/or utilizing the conventional spatial modeling tool so as to achieve high productivity and spatial efficiency while ensuring safety of the human operator (step 1612). For example, the workcell can be configured around areas of danger with minimum wasted space. In addition, the POEs and/or keep-in/keep-out zones can be used to coordinate multi-robot tasks, design collaborative applications in which the operator is expected to occupy some portion of the task-level POE in each robot cycle, estimate workcell (or broader facility) production rates, perform statistical analysis of predicted robot location, speed and power usage over time, and monitor the (wear-and-tear) decay of performance in actuation and position sensing through noise characterization. From the workpiece side, the changing volume of a workpiece can be observed as it is processed, for example, in a subtractive application or a palletizer/depalletizer.

Further, in various embodiments, the control system can transmit the POEs and/or keep-in/keep-out zones to a non-safety-rated component in a robot controller via, for example, the robot communication module 1011 and the non-safety-rated channel 1014 for adjusting the state (e.g., speed, position, etc.) of the machinery (step 1614) so that the machinery is brought to a new, safe state. Subsequently, the control system can transmit instructions including, for example, the new state of the machinery to a safety-rated component in the robot controller for ensuring that the machinery is operated in a safe state (step 1616).

The terms and expressions employed herein are used as terms and expressions of description and not of limitation, and there is no intention, in the use of such terms and expressions, of excluding any equivalents of the features shown and described or portions thereof. In addition, having described certain embodiments of the present teaching, it will be apparent to those of ordinary skill in the art that other embodiments incorporating the concepts disclosed herein may be used without departing from the spirit and scope of the present teaching. Accordingly, the described embodiments are to be considered in all respects as only illustrative and not restrictive.

As described above, a system often desires to compute the POE of an object, e.g. a robot or a human in a workspace, for some point in the future. For example, a robot can be described as a series of links connected by joints, where the current position (and potentially speed) of each joint is known. The system can represent the links as point clouds. In order to efficiently compute the POE, each joint may be “swept” through the possible positions it can reach in a time interval the system is concerned with. Beginning with the furthest out joint, the joint is “swept”, simulating the movement to many possible positions. At each position, the location of the points relative to the next joint is added to a “sweeping cloud”, eventually producing a large point cloud. Then the next joint can be swept, using the sweeping cloud produced by the previous joint as the point cloud representation of the previous joint. By repeating this process from the end-effector toward the base of the robot, the system can obtain a point cloud that represents the possible future positions of the robot. This process takes time proportional to the number of joints, the range of motion of each joint, and the size of each link's point cloud, particularly the end-effector.

The more accurate the link point clouds are, the more accurate the POE will be. In one example, the accuracy of link point clouds may be measured by the maximum distance between a point on the point cloud and a point on the actual link. For example, if the maximum distance is too large, then some part of the mesh is not being represented by the point cloud, or the point cloud contains points that are too distant from the mesh.

In some embodiments, to prevent a system from detecting the robot as a potential human in a workspace, a “blanking zone” is computed for the robot. The blanking zone is a voxel representation of the space occupied by the robot, and includes the sum of the spaces occupied by each link. Sensor measurements within this blanking zone are ignored. When the space is smaller, the position of humans can be more accurately known as humans within the blanking zone are similarly ignored. However, if the space is smaller than the actual robot links, the system may detect the robot as a potential human, causing it to halt the robot.

In some embodiments, while 3D objects are often stored as polygonal meshes, point cloud and voxel representations are more useful for many computational tasks. For example, point cloud representations may be used in POE computation and voxel representations can be used in computing blanking zones. It is thus important to convert polygon meshes to point cloud and voxel representations.

The present teaching discloses an efficient method to generate point cloud and voxel representations from polygon meshes, with a theoretical upper bound for maximum inaccuracy. This conversion can produce point cloud representations that are as small as possible while accurately representing the object. In addition, this conversion also produces voxelizations that accurately represent the object. Further, this conversion is fast, even with very complicated polygon meshes.

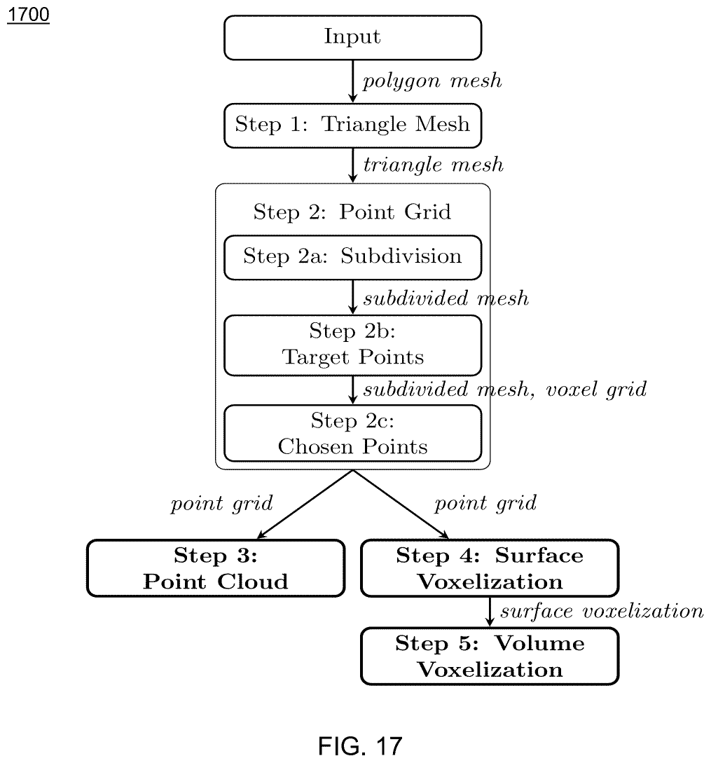

FIG. 17 illustrates a method 1700 for spatially modeling a three-dimensional (3D) object, in accordance with various embodiments of the present teaching. The method 1700 may be implemented by a system to compute both point cloud and voxel representations of objects, with deterministic guarantees of maximum error. In some embodiments, the 3D object may be a robot or a human operator in a workspace. For example, the method 1700 in FIG. 17 can be performed on the robot and/or the human operator, to generate a surface point cloud representation, a surface voxel representation, and a volume voxel representation. The system may computationally generate a first POE for the robot or a second POE for the human operator when performing a task in the workspace, based on at least one of: the surface point cloud representation, the surface voxel representation, or the volume voxel representation. The first and second POEs spatially encompass movements performable by the robot and the human operator, respectively, during performance of the task.

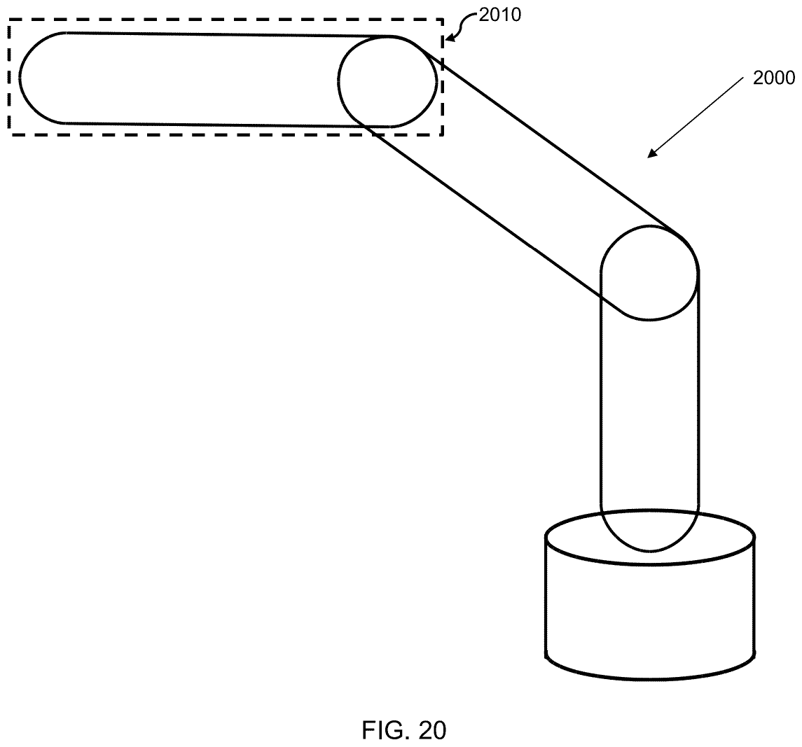

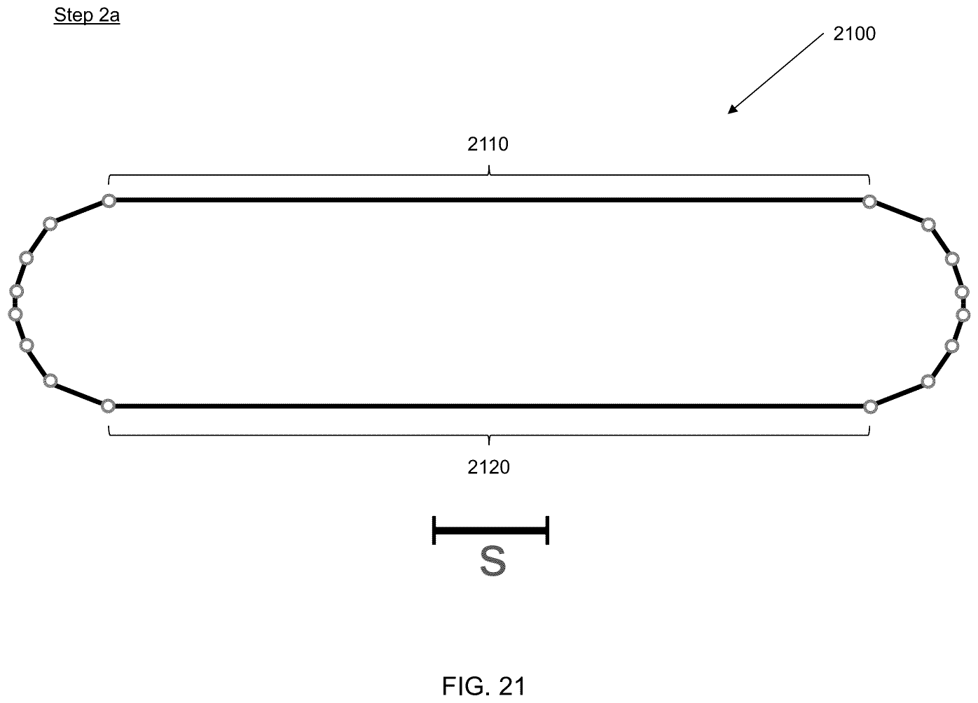

FIG. 20 illustrates a robot 2000 to be spatially modeled, in accordance with various embodiments of the present teaching for exemplary purposes. In various embodiments, the robot 2000 may be any of the robots previously described referring to FIGS. 1-16. A method, e.g. the method 1700 in FIG. 17, can be used to spatially model the robot 2000. For example, a mesh representation of the robot 2000 can be used to generate a point cloud representation, a surface voxelization, and/or a volume voxelization of the robot 2000. As shown in FIG. 20, the robot 2000 has an end effector 2010. For simplicity of illustration, the end effector 2010 will be utilized to show different stages of the spatially modeling method 1700. FIGS. 21-30 illustrate different stages for spatially modeling an end effector of a robot, e.g. the end effector 2010 of the robot 2000 in FIG. 20, in accordance with various embodiments of the present teaching. While the spatially modeling of the end effector 2010 is shown in a two-dimensional (2D) scenario in FIGS. 21-30, the same method of spatially modeling applies in a 3D space.

Referring back to FIG. 17, step 1 of the method 1700 is performed based on an input of a polygon mesh, which includes a set of polygons in three dimensions, representing a surface of a 3D object. At step 1, the polygon mesh may be converted to a triangle mesh. In general, a triangle mesh is a form of polygon mesh where all polygons are triangles. In this example, the triangle mesh is effectively a list of triangles in 3D space.

An example of the step 1 performed in a 2D space is shown in FIG. 21, which illustrates a mesh representation 2100 of an end effector of a robot, e.g. the end effector 2010 of the robot 2000 in FIG. 20, in accordance with various embodiments of the present teaching. While the mesh representation 2100 is formed by multiple line segments in 2D space, a mesh representation for a 3D robot can be formed by multiple polygons or triangles according to step 1 in FIG. 17.

Referring back to FIG. 17, the conversion from the polygon mesh to the triangle mesh in some embodiments is done by dividing each polygon into triangles. For example, by placing a point in the center of each polygon, triangles can be generated by connecting each corner of the polygon to the center. Other approaches can also be utilized for this conversion. The triangle mesh may be used to generate a point grid or point collection at step 2.

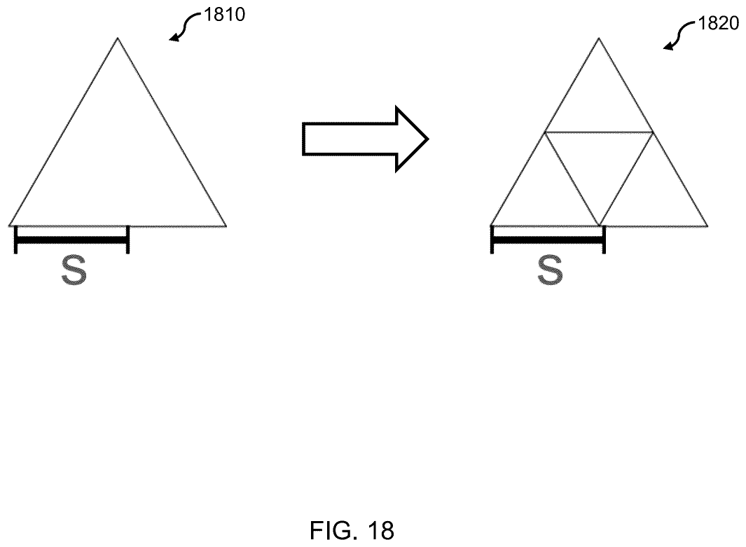

As shown in FIG. 17, the step 2 is directed to generating a point grid. Step 2 may include: a step 2a, a step 2b, and a step 2c. In step 2a, each triangle that contains an edge longer than a predetermined threshold, which may be a fixed constant 5, is subdivided into four smaller triangles. An example of this process is illustrated in FIG. 18. As shown in FIG. 18, one big triangle 1810 whose edge is longer than the threshold S, can be subdivided into four smaller triangles 1820. This process may then be repeated with the resulting triangles, e.g. the four smaller triangles 1820, until no triangle has an edge longer than S. The value of S is a parameter of the calculation, and may be specified in advance. In some embodiments, since each subdivision divides every edge in the triangle in half, this subdivision process at step 2a will take a number of times proportional to log₂ (e/S), where e is a length of the longest edge in the polygon mesh. After the step 2a, the triangle mesh is divided into a subdivided triangle mesh.

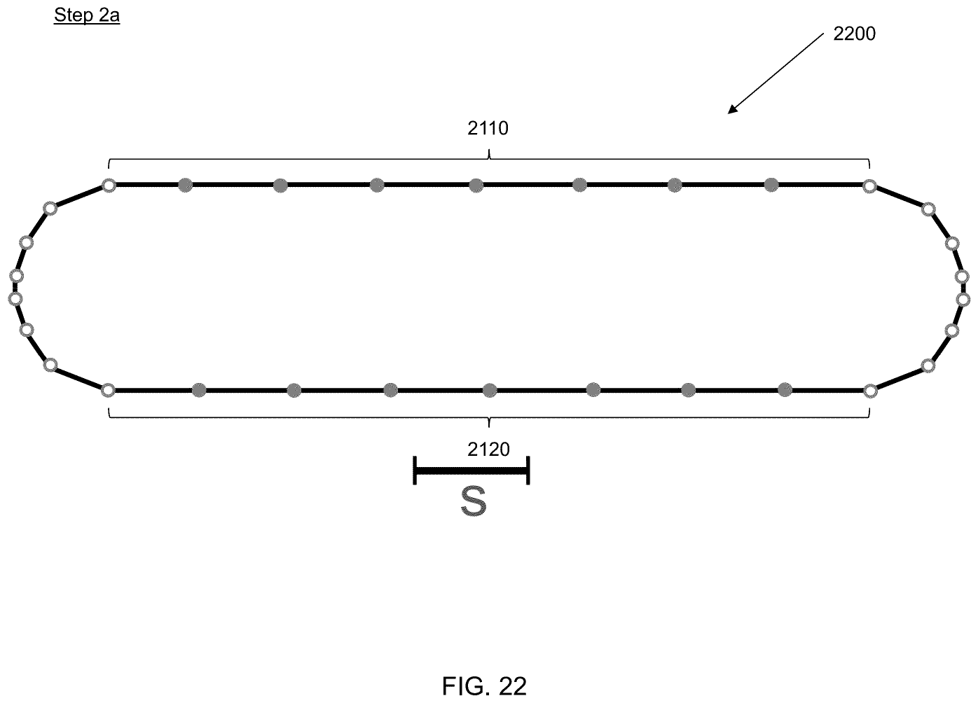

An example of the step 2a performed in a 2D space is shown in FIG. 21 and FIG. 22, where the mesh representation 2100 includes line segments 2110, 2120, which are longer than a predetermined threshold S. Each of these line segments 2110, 2120 longer than 5, may be subdivided into shorter line segments. This subdivision process can be repeated for a predetermined number of times, or until all of the resulting line segments of the subdivision process are shorter than or equal to S. FIG. 22 illustrates a subdivided mesh representation 2200 of an end effector of a robot, in accordance with various embodiments of the present teaching. As shown in FIG. 22, after the subdivision process, the subdivided mesh representation 2200 has no line segment longer than S. This subdivision process shown in FIG. 22 can be similarly performed for a 3D robot according to the step 2a in FIG. 17, to subdivide each triangle having an edge longer than S into four smaller triangles with shorter edges, as shown in FIG. 18. This subdivision process may be performed iteratively for a predetermined number of times, or until all of the resulting triangles of the subdivision process have edges shorter than or equal to S.

Referring back to FIG. 17, at step 2b of the method 1700, the subdivided triangle mesh is overlaid with a 3D voxel grid, which is a grid of cubic voxels. Each voxel in the voxel grid has a size v, which may be a length of each edge of the cubic voxel and can be specified ahead of time as a parameter of the calculation. In each voxel of the grid, the system can randomly select a point in the voxel as a target point of the voxel, wherein the random selection is from uniformly distributed points over the entire volume of the voxel.

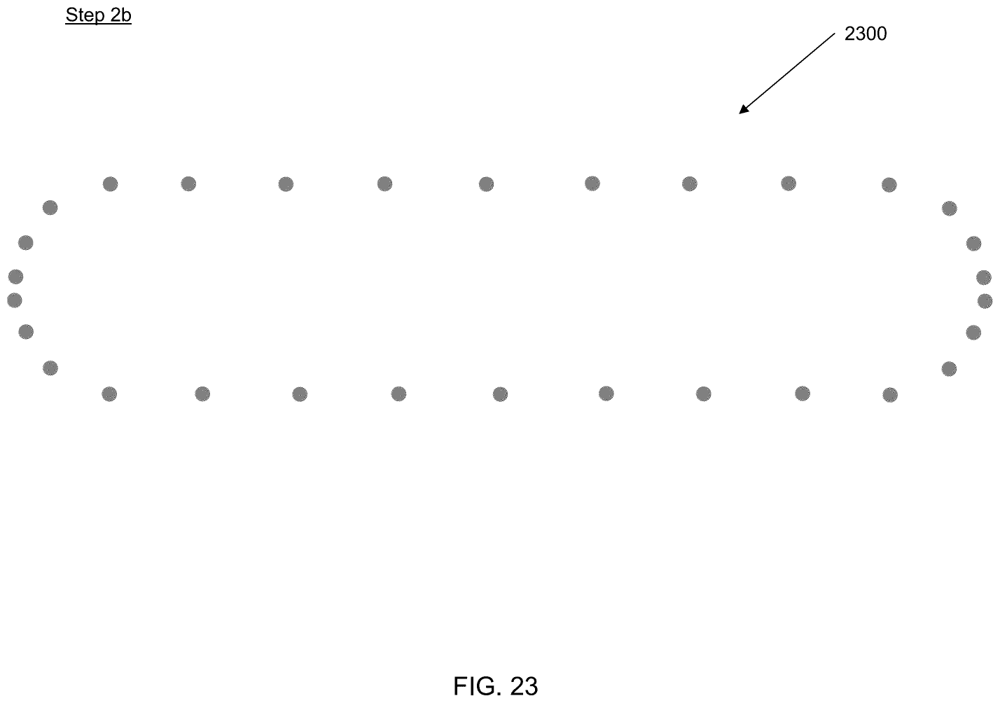

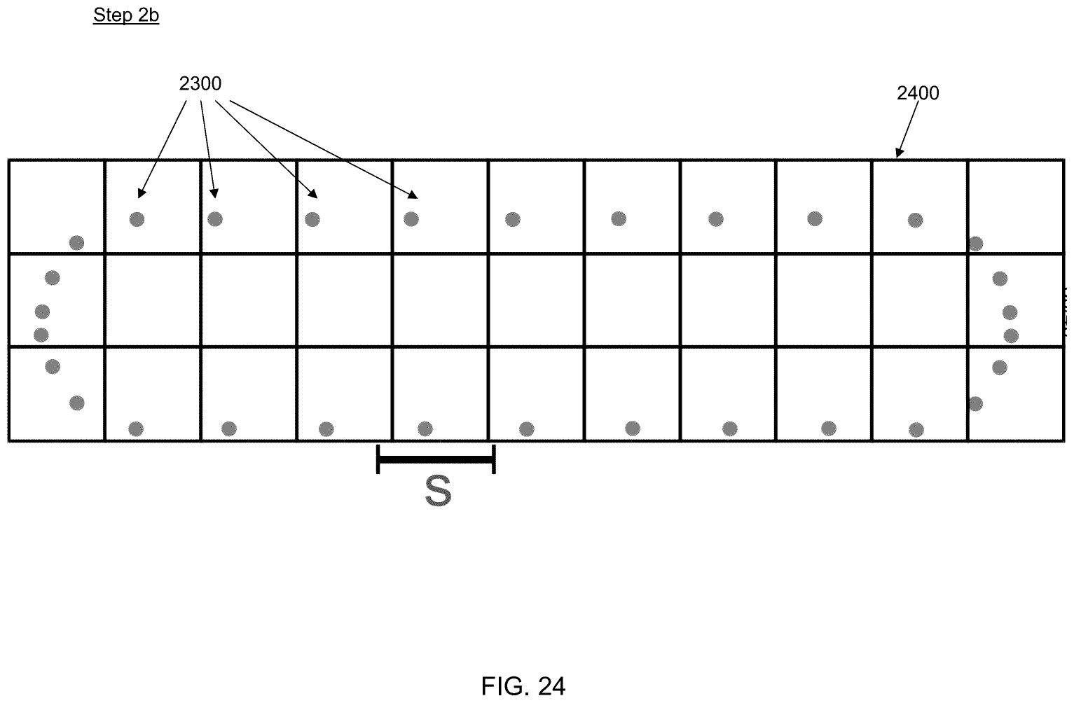

An example of the step 2b performed in a 2D space is shown in FIGS. 23-25. FIG. 23 illustrates endpoints 2300 of a subdivided mesh representation, e.g. the subdivided mesh representation 2200 in FIG. 22, in accordance with various embodiments of the present teaching. FIG. 24 illustrates the endpoints 2300 together with a grid 2400 overlaid on top of the endpoints 2300, in accordance with various embodiments of the present teaching. As shown in FIG. 24, the subdivided mesh representation including the endpoints 2300 is overlaid with a grid 2400 including a grid of square pixels. For a 3D robot, each of the endpoints 2300 would correspond to a vertex of a triangle in a subdivided triangle mesh representation; and each of the square pixels would correspond to a cubic voxel. This overlaid process can be similarly performed for a 3D robot according to the step 2b in FIG. 17, where the subdivided triangle mesh is overlaid with a 3D voxel grid including a grid of cubic voxels.

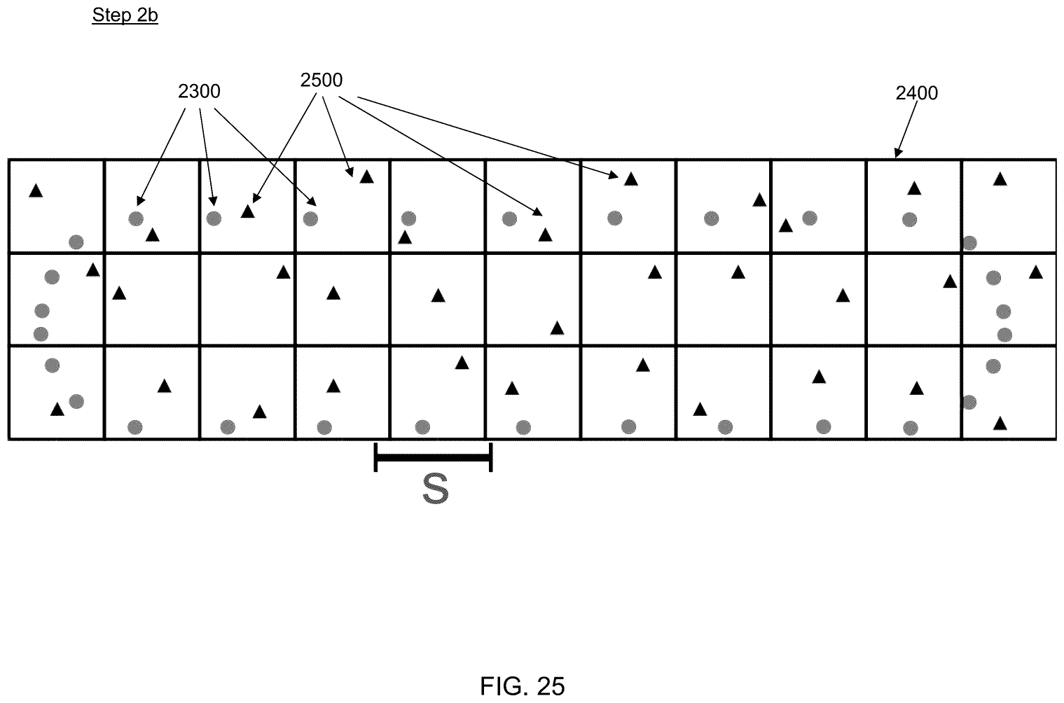

FIG. 25 illustrates target points 2500 in a grid 2400, together with the endpoints 2300, in accordance with various embodiments of the present teaching. As shown in FIG. 25, a point is randomly selected in each pixel of the grid 2400 as a target point for that pixel, e.g. based on a uniform distribution of points over the entire area of the pixel. This target point selection can be similarly performed for a 3D robot according to the step 2b in FIG. 17, where a point is randomly selected in each voxel of the 3D voxel grid as a target point for that voxel, e.g. based on a uniform distribution of points over the entire volume of the voxel.

Referring back to FIG. 17, at step 2c of the method 1700, the system can iterate over every vertex of every triangle in the subdivided triangle mesh. For each vertex, the system can identify a voxel which the vertex is in. If the voxel does not have a chosen point yet, the system sets the vertex as the voxel's chosen point. If the voxel already has an existing chosen point and the current vertex is closer to the voxel's target point than the existing chosen point is, the system sets the current point as a new chosen point to replace the existing chosen point. This produces a voxel grid, where each voxel has zero or one chosen points associated with it, which can be called a point grid or point collection.

In some embodiments, the subdivision at step 2a can produce multiple points in the same location, because some points are used by multiple triangles. For example, one same location may carry vertices of multiple triangles, and is thus visited multiple times at step 2c. The process for generating the chosen points in step 2c can ensure that these points located together are essentially collapsed and do not have a higher likelihood of being picked as a chosen point than a single point at one location, even in the presence of rounding errors. For example, a point at (0,0,0) has the same chance of being picked as a set of points (whether the set includes one or more points) at (1,0,0). This makes the sampling of points in the point collection have a uniform random distribution over the volume of the voxel, such that the point collection can form an accurate and smooth representation of the surface of the object.

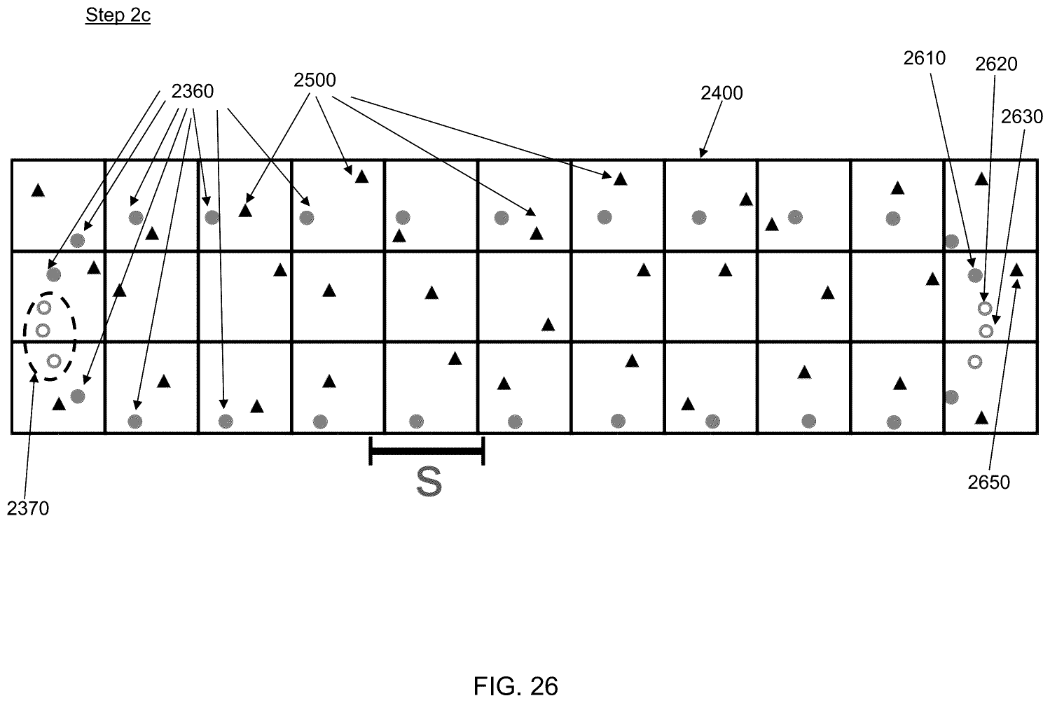

An example of the step 2c performed in a 2D space is shown FIG. 26, which illustrates chosen points 2360 and target points 2500 in a grid 2400, in accordance with various embodiments of the present teaching. As shown in FIG. 26, the chosen points 2360 form a subset of the endpoints 2300. That is, each chosen point is also an endpoint; but not every endpoint is a chosen point. For example, the endpoints 2370 are not chosen points, because every pixel in the grid 2400 can at most have one chosen point. In some examples, there are multiple endpoints in a same pixel, e.g. endpoints 2610, 2620, 2630 are located in a same pixel including a randomly selected target point 2650. In this case, the endpoint 2610, rather than the endpoints 2620, 2630, is set to be a chosen point for that pixel including endpoints 2610, 2620, 2630. This is because the endpoint 2610 is closer to the target point 2650, compared to the other endpoints 2620, 2630 in the same pixel. This process for setting chosen points can be similarly performed for a 3D robot according to the step 2c in FIG. 17, where for each voxel having one or more vertices, a chosen point is set to be the vertex closest to the target point in the voxel.

Referring back to FIG. 17, in order to reduce the computation time of step 2 of the method 1700, the system can generate the point collection in an efficient manner in some embodiments. Rather than first performing step 2a then performing step 2b, the system can compute both at the same time. For example, the system can iterate over every triangle in the original triangle mesh before subdivision. For each triangle (referred to as triangle A) in the original triangle mesh, if triangle A has an edge larger than S, the system subdivides it as previously described and recursively performs the same computation on each newly created triangle, until each edge of every newly created triangle from triangle A is shorter than or equal to S. When triangle A does not include any triangle having an edge larger than 5, the system performs steps 2b and 2c on each vertex in triangle A. For example, the system overlays each triangle generated from triangle A with one or more voxels in the voxel grid. Then for each voxel overlaying a triangle generated from triangle A, the system can randomly and uniformly select a target point in the voxel, and determine a chosen point in the voxel based on a vertex of the triangle that is closer to the target point compared to any other vertex in the voxel. That is, the system can retain and store a single chosen point for each voxel, and override the stored point if the new one is closer to the target point. The system then continues onward to the next triangle in the original triangle mesh, until all the triangles are visited to generate the chosen points in the voxel grid. This allows the system to avoid ever storing the entire subdivided triangle mesh, which substantially reduces the memory requirement for the method.

At step 3 of the method 1700, the system can extract each chosen point from the voxels of the voxel grid, to produce a surface point cloud for the 3D object. In some embodiments, for a voxel size v and a subdivision constant S, the maximum distance between a point on the surface of the 3D object and a point in the point cloud is approximately v*0.408*\sqrt{S²+2.828S+18}. The number of points in this point cloud is proportional to v and the size of the mesh's bounding box, and is independent of the level of detail of the original polygon mesh or the number of polygons in the original polygon mesh. In some embodiments, the number of points in the point cloud can be adjusted by adjusting v and 5, and is strictly bounded by the size of the mesh's bounding box.

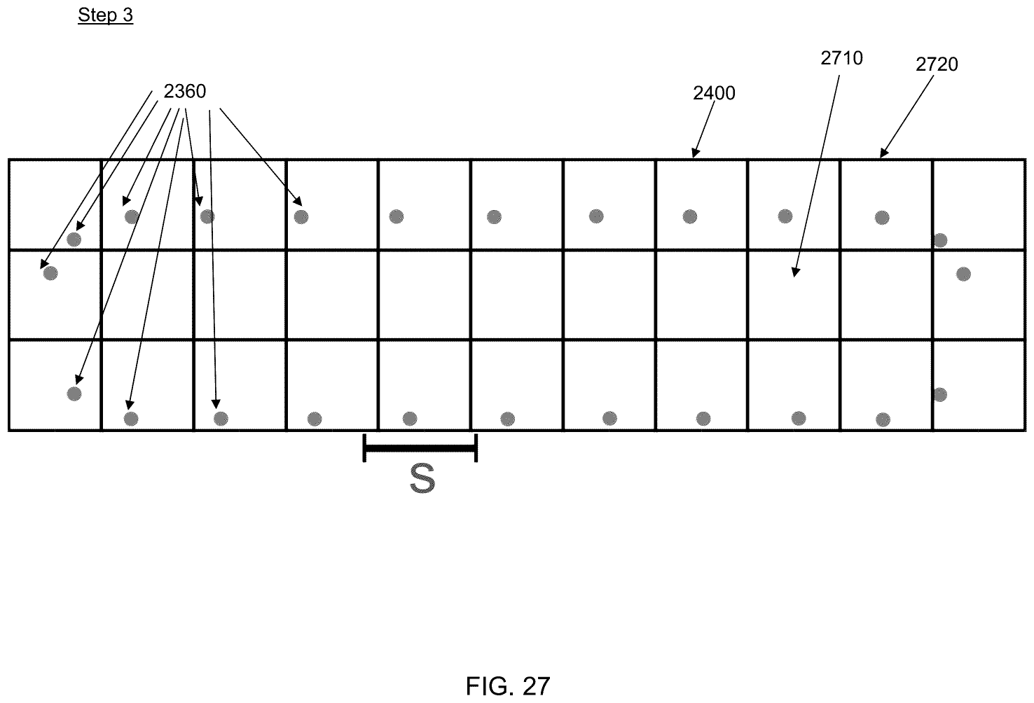

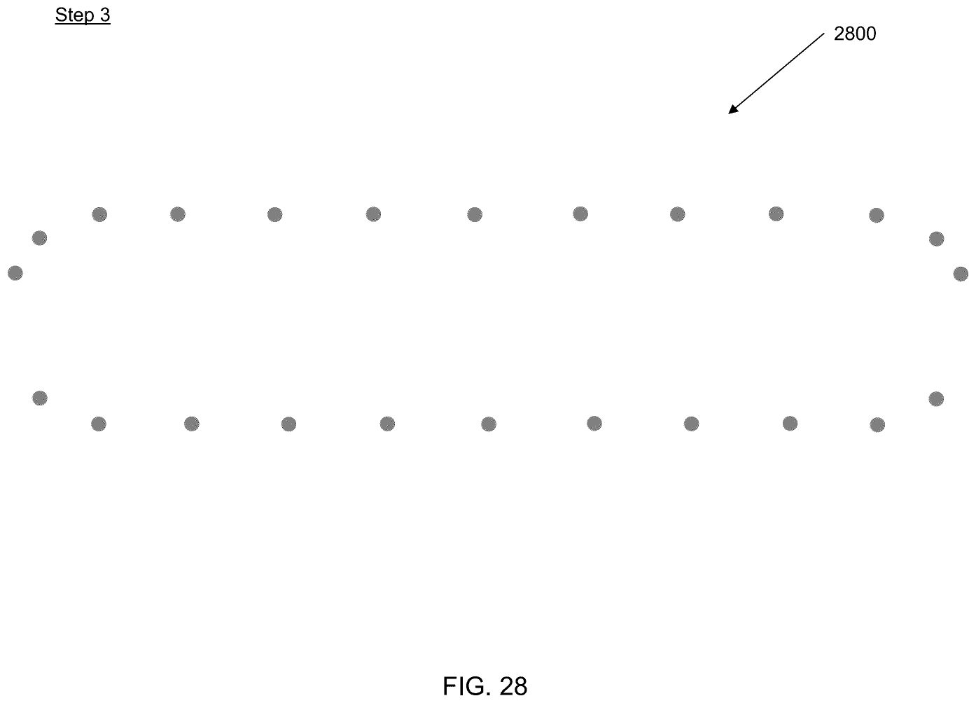

An example of the step 3 performed in a 2D space for illustrative purposes is shown FIG. 27 and FIG. 28. FIG. 27 illustrates chosen points 2360 in a grid 2400, in accordance with various embodiments of the present teaching. As shown in FIG. 27, each pixel in the grid 2400 has zero or one chosen point. For example, the pixel 2710 has zero chosen points, while the pixel 2720 has one chosen point. Similarly for a 3D robot, each voxel in the 3D voxel grid has zero or one chosen point.

FIG. 28 illustrates a point cloud 2800 as a surface representation of an end effector of a robot, e.g. the end effector 2010 of the robot 2000 in FIG. 20, in accordance with various embodiments of the present teaching. As shown in FIG. 28, the point cloud 2800 includes all chosen points extracted from the pixels of the grid 2400 in FIG. 27. Since each pixel in the grid 2400 has at most one chosen point, no pixel is over-represented by the point cloud 2800. Since each pixel in the grid 2400 had a target point, no pixel is under-represented by the point cloud 2800 compared to the mesh representation. This process for generating a point cloud can be similarly performed for a 3D robot according to step 3 in FIG. 17, where all chosen points are extracted from the voxels of the voxel grid to generate a surface point cloud for the robot. Since each voxel in the voxel grid has one target point and at most one chosen point, no voxel is overrepresented or under-represented by the point cloud compared to the mesh representation.

Referring back to FIG. 17, at step 4 of the method 1700, the system can mark each voxel that has a chosen point associated with it. This produces a surface voxelization of the surface of the 3D object by the marked voxels. In general, a surface voxelization is a voxelization that only contains voxels occupied by the surface of an object. In some embodiments, if S is less than v and the original polygon mesh did not have holes, this surface voxelization will not have axis-aligned holes.

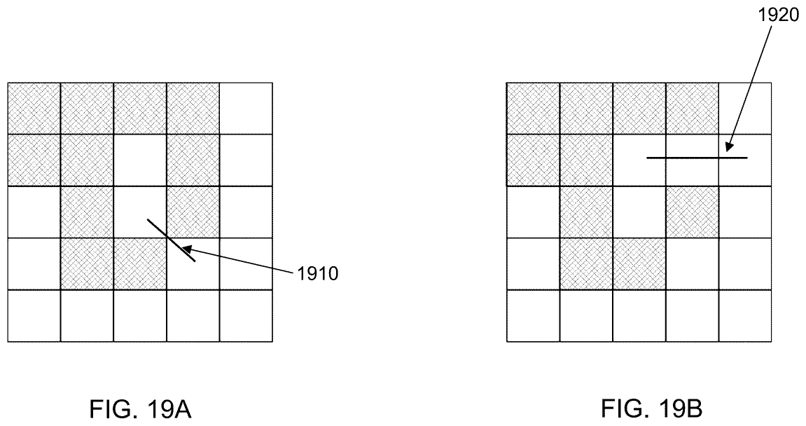

A hole may be defined as a gap between two polygons. FIGS. 19A and 19B illustrate the difference between axis-aligned and diagonal holes in the two-dimensional scenario, while the same principle applies in 3D space. FIG. 19A shows a polygon mesh with an exemplary diagonal hole 1910 but without any axis-aligned hole. As shown in FIG. 19A, the diagonal hole 1910 is a hole between two adjacent polygons that align to each other along a diagonal of polygon. FIG. 19B shows a polygon mesh with an exemplary axis-aligned hole 1920, which is a hole between two adjacent polygons that align to each other along an axis of the polygon mesh or along an edge of polygon.

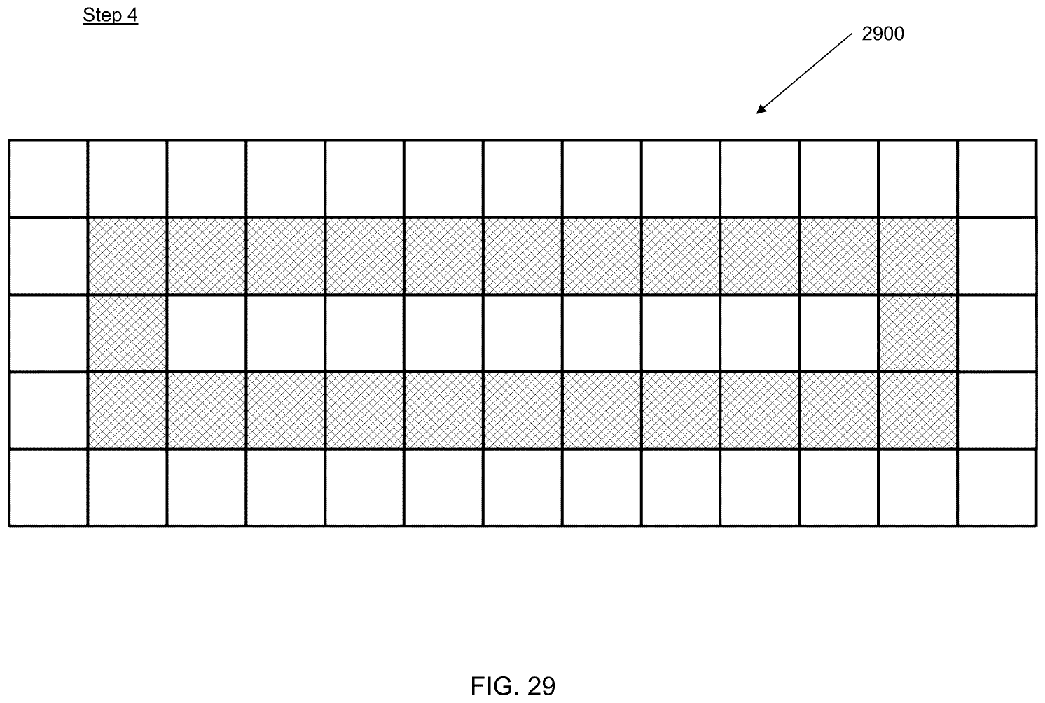

An example of the step 4 performed in a 2D space is shown FIG. 29, which illustrates a surface voxelization 2900 of an end effector of a robot, e.g. the end effector 2010 of the robot 2000 in FIG. 20, in accordance with various embodiments of the present teaching. As shown in FIG. 29, the surface voxelization 2900 is formed by all pixels that have chosen points in the grid 2400. This process for generating a surface voxelization can be similarly performed for a 3D robot according to the step 4 in FIG. 17, where each voxel that has a chosen point associated with it is marked and selected to form a surface voxelization for the robot.

Referring back to FIG. 17, at step 5 of the method 1700, the system can generate a volume voxelization of the 3D object, by expanding the voxel grid by one voxel outward in both the positive and negative direction of the x, y, and z axis. The system may perform a flood fill algorithm on the empty space, starting from one corner of the voxel grid. Importantly, the flood fill algorithm is only performed along the axis directions, not diagonally. The flood fill algorithm may be based on many techniques including but not limited to depth-first search. Once this flood fill is completed, the set of non-marked voxels may form a voxelization of the volume of the 3D object, even if the surface is discontinuous. This is not a full cover, and contains slightly fewer voxels than a full cover would. In some embodiments, the maximum distance from the surface to the center of a voxel is v*0.288*\sqrt{2S²+2.828S+9}. In some embodiments, if the original polygon mesh was not hole free, the interior of the shape may not be filled.

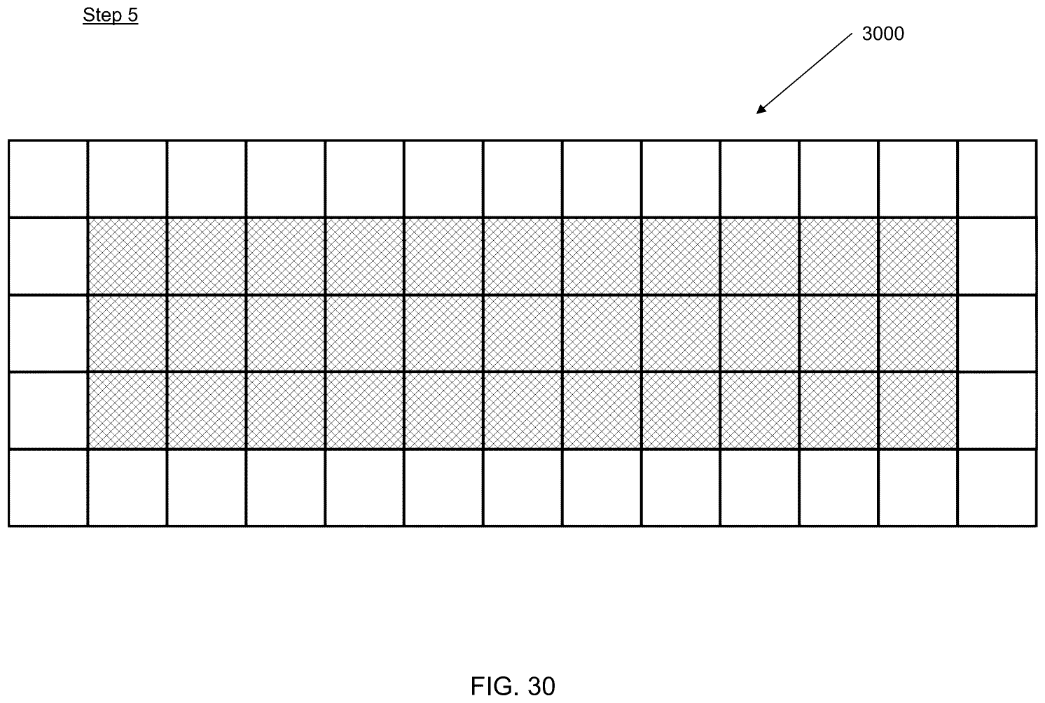

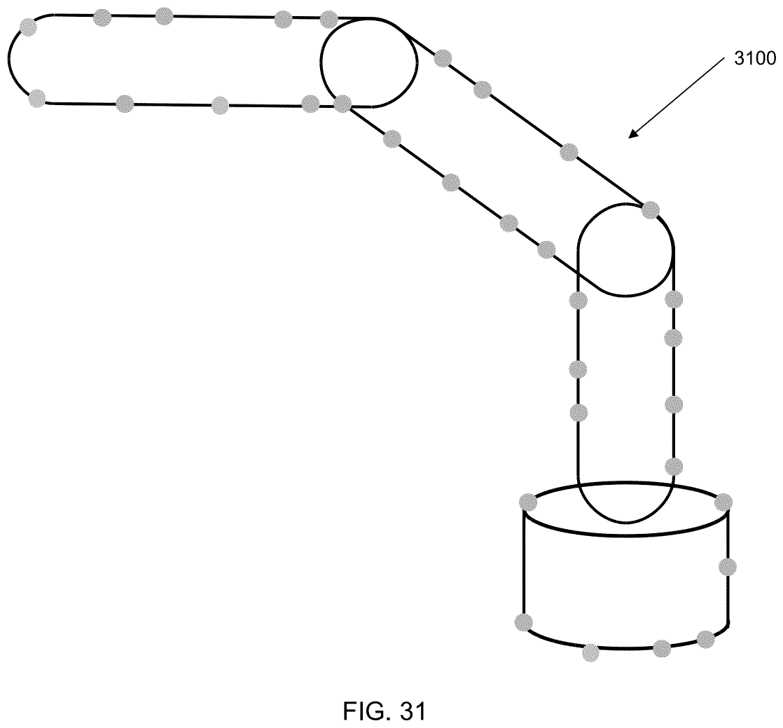

An example of the step 5 performed in a 2D space is shown FIG. 30, which illustrates a volume voxelization 3000 of an end effector of a robot, e.g. the end effector 2010 of the robot 2000 in FIG. 20, in accordance with various embodiments of the present teaching. As shown in FIG. 30, for one surface of the robot 2000, the volume voxelization 3000 may be formed by expanding the pixels in the surface voxelization 2900 along different directions. This process for generating a volume voxelization can be similarly performed for a 3D robot according to the step in FIG. 17, where the volume voxelization for the robot may be generated based on a surface voxelization and a flood fill algorithm.

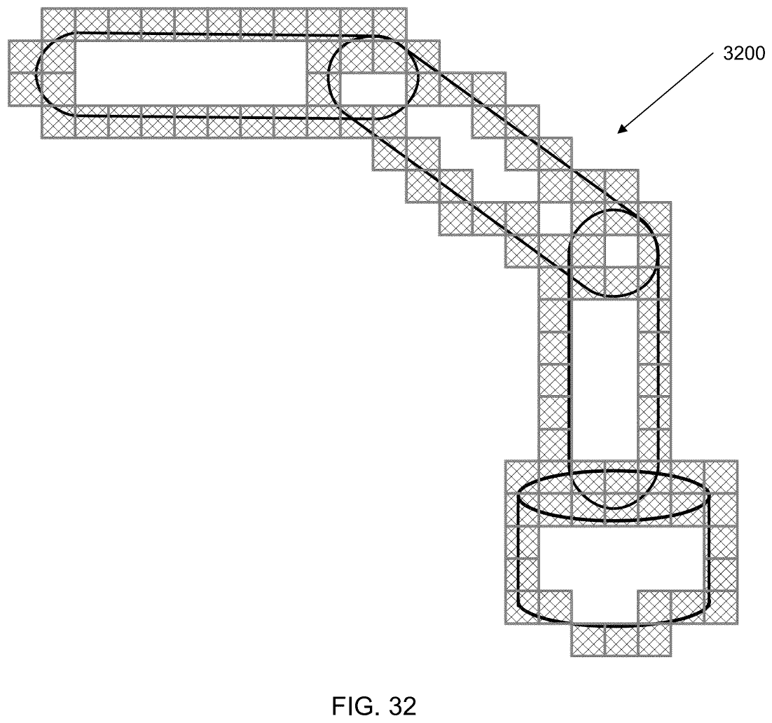

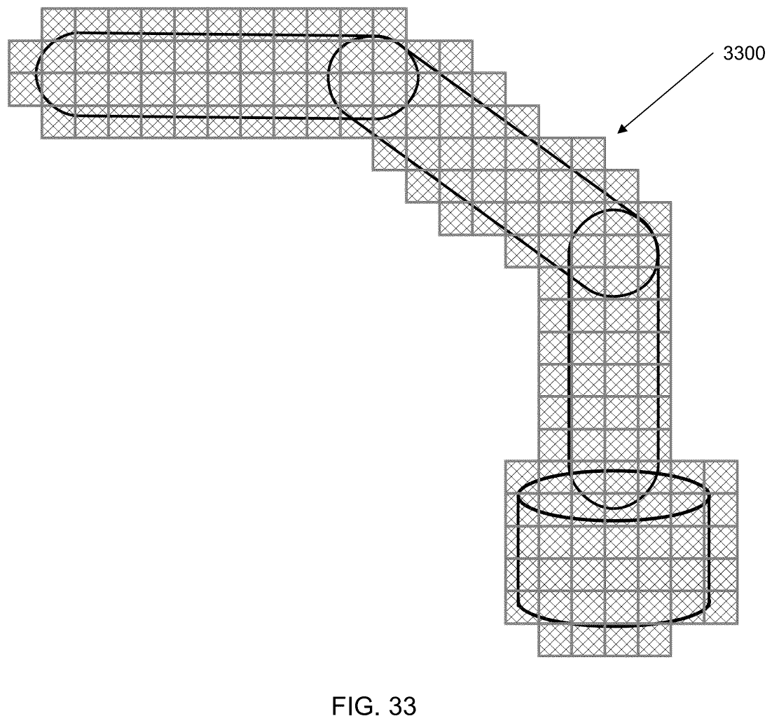

FIG. 31 illustrates a point cloud representation 3100 of a robot, e.g. the robot 2000 in FIG. 20, in accordance with various embodiments of the present teaching. In addition, FIG. 32 illustrates a surface voxelization 3200 of the robot; and FIG. 33 illustrates a volume voxelization 3300 of the robot (as best illustrated in a 2D representation), in accordance with various embodiments of the present teaching. Each of the point cloud representation 3100, the surface voxelization 3200 and the volume voxelization 3300, may be generated according to the method 1700 in FIG. 17, as discussed above.

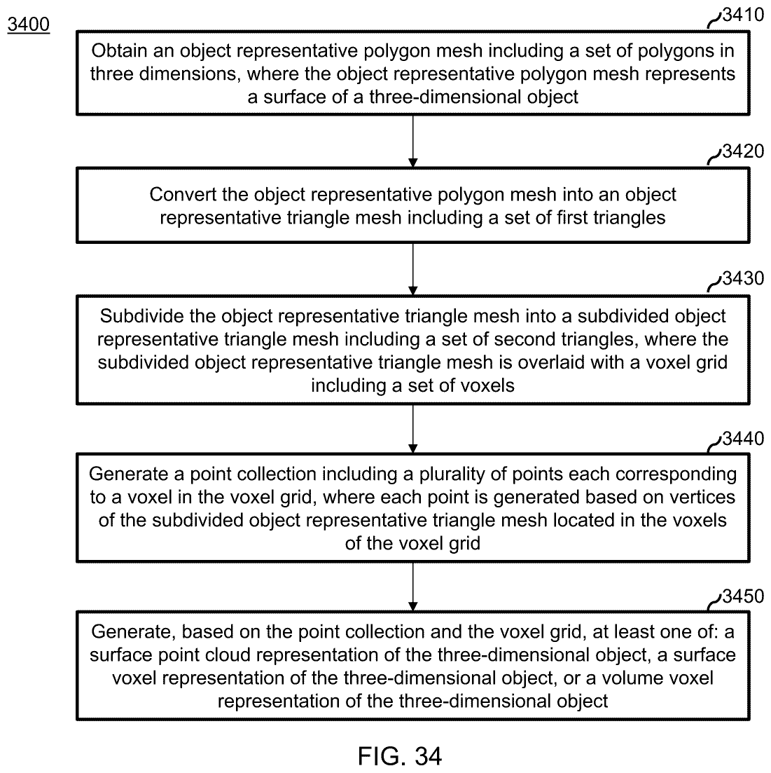

FIG. 34 is a flow chart illustrating a method 3400 for spatially modeling a 3D object, in accordance with various embodiments of the present teaching. In some embodiments, the method 3400 can be carried out by one or more systems as described in FIGS. 1-19. Beginning at operation 3410, an object representative polygon mesh including a set of polygons in three dimensions is obtained. The object representative polygon mesh represents a surface of the 3D object. At operation 3420, the object representative polygon mesh is converted into an object representative triangle mesh including a set of first triangles. At operation 3430, the object representative triangle mesh is subdivided into a subdivided object representative triangle mesh including a set of second triangles. The subdivided object representative triangle mesh is overlaid with a voxel grid including a set of voxels. At operation 3440, a point collection is generated to include a plurality of points each corresponding to a voxel in the voxel grid. Each point may be generated based on vertices of the subdivided object representative triangle mesh located in the voxels of the voxel grid. At operation 3450, based on the point collection and the voxel grid, the system can generate at least one of: a surface point cloud representation of the 3D object, a surface voxel representation of the 3D object, or a volume voxel representation of the 3D object.

Although the methods described above are with reference to the illustrated flowcharts, it will be appreciated that many other ways of performing the acts associated with the methods can be used. For example, the order of some operations may be changed, and some of the operations described may be optional.

As such, the present teaching discloses a method to use a polygon mesh to produce one or more of the following (as desired by the user): a point cloud representation with strictly bounded maximum error, a surface voxelization which is hole-free if the original polygon mesh was, and a volume voxelization if the original polygon mesh was hole-free. In some embodiments, the method takes time proportional to the number of polygons in the polygon mesh times the length of the longest edge, divided by the value of the subdivision constant S. When the voxel size v is very small, then the run time is roughly proportional to v⁻³. This method allows the system to improve the accuracy of POE calculation without increasing the initial time to compute the clouds. This method also allows the system to increase the accuracy of blanking zone calculation, while substantially reducing the time to compute the voxelization of each robot link.

In some embodiments, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that the computer becomes a special purpose computer for practicing the methods. When implemented on a general-purpose processor, the computer program code segments configure the processor to create specific logic circuits. The methods may alternatively be at least partially embodied in application specific integrated circuits for performing the methods. In some embodiments, each functional component described herein can be implemented in computer hardware, in program code, and/or in one or more computing systems executing such program code as is known in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. A method for spatially modeling a three-dimensional object, the method comprising:
obtaining an object representative polygon mesh including a set of polygons in three dimensions, wherein the object representative polygon mesh represents a surface of the three-dimensional object;
converting the object representative polygon mesh into an object representative triangle mesh including a set of first triangles;
subdividing the object representative triangle mesh into a subdivided object representative triangle mesh including a set of second triangles, wherein the subdivided object representative triangle mesh is overlaid with a voxel grid including a set of voxels;
generating a point collection including a plurality of points each corresponding to a voxel in the voxel grid, wherein each point is generated based on vertices of the subdivided object representative triangle mesh located in the voxels of the voxel grid; and
generating, based on the point collection and the voxel grid, at least one of: a surface point cloud representation of the three-dimensional object, a surface voxel representation of the three-dimensional object, or a volume voxel representation of the three-dimensional object.

2. The method of claim 1, wherein:
the object representative polygon mesh is converted into the object representative triangle mesh by dividing each polygon in the object representative polygon mesh into a subset of first triangles of the set of first triangles.

3. The method of claim 1, wherein the subdivided object representative triangle mesh is generated based on:
subdividing, for each first triangle in the set of first triangles, the first triangle into N smaller triangles, where N is greater than 1, if the first triangle contains an edge longer than a predetermined threshold, to generate an updated triangle mesh; and
repeating the subdividing step for each triangle in the updated triangle mesh until each edge of every triangle is shorter than or equal to the predetermined threshold, to generate the subdivided object representative triangle mesh.

4. The method of claim 3, further comprising:
overlaying the subdivided object representative triangle mesh with the voxel grid; and
determining a target point in each voxel of the voxel grid.

5. The method of claim 4, wherein determining the target point in each voxel comprises:
randomly selecting a point in the voxel as the target point, wherein the randomly selecting is based on a uniform distribution of points over an entire volume of the voxel.

6. The method of claim 4, wherein generating the point collection comprises:
for each vertex in the subdivided object representative triangle mesh,
identifying, from the voxel grid, a voxel encompassing the vertex;
if the voxel is associated with a chosen point,
determining whether the vertex is closer to the target point in the voxel compared to the chosen point, and
in response to a determination that the vertex is closer to the target point in the voxel compared to the chosen point, setting the vertex as a new chosen point to replace the chosen point for the voxel; and
if the voxel is not associated with a chosen point, setting the vertex as a chosen point for the voxel.

7. The method of claim 6, wherein:
the surface point cloud representation of the three-dimensional object is generated based on extracting chosen points from the voxels of the voxel grid, wherein the chosen points form the surface point cloud representation of the three-dimensional object;
the surface voxel representation of the three-dimensional object is generated based on marking, in the point collection, each voxel that has a chosen point, wherein the marked voxels form the surface voxel representation of the three-dimensional object; and
the volume voxel representation of the three-dimensional object is generated based on expanding, starting from a corner of the voxel grid, the voxel grid along axis directions to generate an expanded voxel grid that forms the volume voxel representation of the three-dimensional object.

8. The method of claim 1, further comprising:
for each first triangle in the set of first triangles,
subdividing the first triangle into N smaller triangles, where N is greater than 1, if the first triangle contains an edge longer than a predetermined threshold;
repeating the subdividing step for each of the N smaller triangles until each edge of every triangle generated from the first triangle is shorter than or equal to the predetermined threshold;
overlaying each triangle generated from the first triangle with one or more voxels in the voxel grid; and
for each voxel overlaying a triangle generated from the first triangle,
randomly selecting a target point in the voxel, and
determining a chosen point in the voxel based on a vertex of the triangle that is closer to the target point compared to any other vertex in the voxel.

10. The method of claim 1, wherein the three-dimensional object is a robot or a human operator in a workspace.

11. The method of claim 10, further comprising:
computationally generating a first potential occupancy envelope for the robot or a second potential occupancy envelope for the human operator when performing a task in the workspace, based on at least one of: the surface point cloud representation, the surface voxel representation, or the volume voxel representation,
wherein the first and second potential occupancy envelopes spatially encompass movements performable by the robot and the human operator, respectively, during performance of the task.

12. A system for spatially modeling a three-dimensional object, the system comprising:
a non-transitory memory having instructions stored thereon; and
at least one processor operatively coupled to the non-transitory memory, and configured to read the instructions to:
obtain an object representative polygon mesh including a set of polygons in three dimensions, wherein the object representative polygon mesh represents a surface of the three-dimensional object,
convert the object representative polygon mesh into an object representative triangle mesh including a set of first triangles,
subdivide the object representative triangle mesh into a subdivided object representative triangle mesh including a set of second triangles, wherein the subdivided object representative triangle mesh is overlaid with a voxel grid including a set of voxels,
generate a point collection including a plurality of points each corresponding to a voxel in the voxel grid, wherein each point is generated based on vertices of the subdivided object representative triangle mesh located in the voxels of the voxel grid, and
generate, based on the point collection and the voxel grid, at least one of: a surface point cloud representation of the three-dimensional object, a surface voxel representation of the three-dimensional object, or a volume voxel representation of the three-dimensional object.

13. The system of claim 12, wherein the subdivided object representative triangle mesh is generated based on:
subdividing, for each first triangle in the set of first triangles, the first triangle into N smaller triangles, where N is greater than 1, if the first triangle contains an edge longer than a predetermined threshold, to generate an updated triangle mesh; and
repeating the subdividing step for each triangle in the updated triangle mesh until each edge of every triangle is shorter than or equal to the predetermined threshold, to generate the subdivided object representative triangle mesh.

14. The system of claim 13, wherein the at least one processor is further configured to read the instructions to:
overlay the subdivided object representative triangle mesh with the voxel grid; and
determine a target point in each voxel of the voxel grid, by randomly selecting a point in the voxel as the target point based on a uniform distribution of points over an entire volume of the voxel.

15. The system of claim 13, wherein the point collection is generated based on:
for each vertex in the subdivided object representative triangle mesh,
identifying, from the voxel grid, a voxel encompassing the vertex;
if the voxel is associated with a chosen point,
determining whether the vertex is closer to the target point in the voxel compared to the chosen point, and
in response to a determination that the vertex is closer to the target point in the voxel compared to the chosen point, setting the vertex as a new chosen point to replace the chosen point for the voxel; and
if the voxel is not associated with a chosen point, setting the vertex as a chosen point for the voxel.

16. The system of claim 12, wherein:
the surface point cloud representation of the three-dimensional object is generated based on extracting chosen points from the voxels of the voxel grid, wherein the chosen points form the surface point cloud representation of the three-dimensional object;
the surface voxel representation of the three-dimensional object is generated based on marking, in the point collection, each voxel that has a chosen point, wherein the marked voxels form the surface voxel representation of the three-dimensional object; and
the volume voxel representation of the three-dimensional object is generated based on expanding, starting from a corner of the voxel grid, the voxel grid along axis directions to generate an expanded voxel grid that forms the volume voxel representation of the three-dimensional object.

17. The system of claim 12, wherein the at least one processor is further configured to read the instructions to:
for each first triangle in the set of first triangles,
subdivide the first triangle into N smaller triangles, where N is greater than 1, if the first triangle contains an edge longer than a predetermined threshold;
repeat the subdividing step for each of the N smaller triangles until each edge of every triangle generated from the first triangle is shorter than or equal to the predetermined threshold;
overlay each triangle generated from the first triangle with one or more voxels in the voxel grid; and
for each voxel overlaying a triangle generated from the first triangle,
randomly select a target point in the voxel, and
determine a chosen point in the voxel based on a vertex of the triangle that is closer to the target point compared to any other vertex in the voxel.

18. The system of claim 12, wherein the three-dimensional object is a robot or a human operator in a workspace.

19. The system of claim 18, wherein the at least one processor is further configured to read the instructions to:
computationally generate a first potential occupancy envelope for the robot or a second potential occupancy envelope for the human operator when performing a task in the workspace, based on at least one of: the surface point cloud representation, the surface voxel representation, or the volume voxel representation,
wherein the first and second potential occupancy envelopes spatially encompass movements performable by the robot and the human operator, respectively, during performance of the task.

20. A non-transitory computer readable medium having instructions stored thereon for spatially modeling a three-dimensional object, wherein the instructions, when executed by at least one processor, cause at least one device to perform operations comprising:
obtaining an object representative polygon mesh including a set of polygons in three dimensions, wherein the object representative polygon mesh represents a surface of the three-dimensional object;
converting the object representative polygon mesh into an object representative triangle mesh including a set of first triangles;
subdividing the object representative triangle mesh into a subdivided object representative triangle mesh including a set of second triangles, wherein the subdivided object representative triangle mesh is overlaid with a voxel grid including a set of voxels;
generating a point collection including a plurality of points each corresponding to a voxel in the voxel grid, wherein each point is generated based on vertices of the subdivided object representative triangle mesh located in the voxels of the voxel grid; and
generating, based on the point collection and the voxel grid, at least one of: a surface point cloud representation of the three-dimensional object, a surface voxel representation of the three-dimensional object, or a volume voxel representation of the three-dimensional object.
